(19) United States
(12) Patent Application Publication
(10) Pub. No.: US 2011/0153379 A1
(43) Pub. Date: Jun. 23, 2011

(54) STAFF ARRANGEMENT SYSTEM AND SERVER

(76) Inventors: Minako Toba, Tokyo (JP); Yasuhide Mori, Kawasaki (JP); Ken Naono, Tokyo (JP); Masashi Egi, Machida (JP); Takao Sakurai, Tachikawa (JP)

(21) Appl. No.: 12/866,703

(22) PCT Filed: Jul. 30, 2009
(86) PCT No.: PCT/JP2009/063570

§ 371 Date: Aug. 6, 2010

(51) Int. Cl. G06Q 10/00

(52) U.S. Cl. 705/7.14; 705/7.17

(57) ABSTRACT

According to one embodiment of the present invention, a skill level of a staff member is discriminated from an actual job log of the staff member, productivity including the skill level, a salary, and combination efficiency with another staff member is calculated, and a staff arrangement plan maximizing a productive efficiency is outputted. A system of calculating an optimum staff arrangement of staff arrangements for a job operated by a plurality of staff members, includes: a record database for a job amount generated during a certain period; a profile database for staff members; a combination-efficiency database for staff members; a skill-level database for staff members; means of acquiring a staff-profile data; means of acquiring a record of a past-generated job amount; means of calculating combination efficiency between staff members; means of predicting a job demand of the job in a specific period, from the record of the past-generated job amount; means of calculating the required number of staff members from the predicted job demand; means of calculating a working shift satisfying the required number of staff members; means of calculating a working-shift matching degree from data of the combination efficiency with the staff member and the working shift; means of performing an arrangement plan corresponding to the required number of staff members by sequentially arranging staff members in descending order of the high matching degree; and means of calculating productive efficiency of the arrangement plan, so that the arrangement plan having the highest productive efficiency is shown.

### TECHNICAL FIELD

The present invention relates to a staff arrangement system and a staff arrangement method in a place of work in which a plurality of people share jobs, such as a call center, retail distribution industry, and a bank teller window.

### BACKGROUND ART

Conventionally, in a place of work in which a plurality of people share jobs, a staff arrangement plan of planning what job is assigned to each staff member is determined based on job demand prediction such as prediction of the number of incoming calls in a call center.

Patent Document 1 discloses a method and a system capable of simulating levels of operators and the number of arranged operators, which are ensured with certain input money, from a database for performance levels of the operators and salaries corresponding to the performance levels based on the predicted number of incoming calls.

Patent Document 2 discloses a staff arrangement system having a database on which job performances of workers are recorded, which forms a team assigned for one job with high-job-performance workers and low-job-performance workers and outputs information of the team.

### PRIOR ART DOCUMENTS

### Patent Documents

Patent Document 1: Japanese Patent No. 3953785

Patent Document 2: Japanese Patent Application Laid-Open

### DISCLOSURE OF THE INVENTION

### Problems to be Solved by the Invention

However, information of job-supply side such as performances of staff members is generally made by self-reported information from each staff member or individual judgment by a manager, and therefore, a method has not been proposed in which optimum staff arrangement in consideration of objective skill levels of the staff members and productive efficiencies obtained by combinations with a plurality of staff members is outputted, and as a result, there arises a problem that the staff arrangement having the best productive efficiency is not provided.

### Means for Solving the Problems

Accordingly, for solving at least one problem, an embodiment of the present invention is for generating a staff arrangement plan based on productivity including combinations with a plurality of staff members obtained from actual job logs of the staff members, and outputting the staff arrangement plan.

### Effects of the Invention

According to a typical embodiment of the present invention, a staff arrangement plan in accordance with productive efficiency can be calculated.

### BRIEF DESCRIPTIONS OF THE DRAWINGS

FIG. 1 is a diagram illustrating one example of a system configuration according to a first embodiment;

FIG. 2 is a diagram illustrating one example of a software configuration of an apparatus according to the first embodiment;

FIG. 3 is a diagram illustrating one example of a staff registration screen according to the first embodiment;

FIG. 4 is a diagram illustrating one example of a staff profile according to the first embodiment;

FIG. 5 is a diagram illustrating one example of a PC operation log according to the first embodiment;

FIG. 6 is a diagram illustrating one example of a staff-analysis database according to the first embodiment;

FIG. 7 is a diagram illustrating one example of a process flow of calculating a skill level from the PC operation log according to the first embodiment;

FIG. 8 is a diagram illustrating one example of a process flow of calculating combination efficiency according to the first embodiment;

FIG. 9 is a diagram illustrating one example of a team-formation database of staff members according to the first embodiment;

FIG. 10 is a diagram illustrating one example of transition of the predicted number of incoming calls according to the first embodiment;

FIG. 11 is a diagram illustrating one example of the optimum number of staff members according to the first embodiment;

FIG. 12 is a diagram illustrating one example of a process flow of calculating optimum staff arrangement according to the first embodiment;

FIG. 13 is a diagram illustrating one example of an arrangement plan according to the first embodiment;

FIG. 14 is a diagram illustrating one example of transition of predicted productive efficiency according to the first embodiment;

FIG. 15 is a diagram illustrating one example of the productive efficiency of the arrangement plan according to the first embodiment;

FIG. 16 is a diagram illustrating one example of a calculation start screen according to the first embodiment;

FIG. 17 is a diagram illustrating one example of the calculation start screen when a condition is provided for the combination efficiency, according to the first embodiment;

FIG. 18 is a diagram illustrating one example of an output screen for the calculated result according to the first embodiment;

FIG. 19 is a diagram illustrating one example of a screen for a daily report in which a comparison of the calculated result with an actual result is outputted, according to the first embodiment;

FIG. 20 is a diagram illustrating one example of a process flow of calculating an item significantly affecting a difference between the prediction and the result in the productive efficiency;

FIG. 21 is a diagram illustrating one example of a member-absent risk of an arrangement plan according to a second embodiment;

FIG. 22 is a diagram illustrating one example of feasible probability of productive efficiency to which the member-absent risk is added, according to the second embodiment;

FIG. 23 is a diagram illustrating one example of maximum and target productive efficiency of the arrangement plan according to the second embodiment;

FIG. 24 is a diagram illustrating one example of a calculation start screen for the arrangement plan according to the second embodiment;

FIG. 25 is a diagram illustrating one example of an output screen for a calculated result according to the second embodiment;

FIG. 26 is a diagram illustrating one example of transition of a predicted job amount in each job according to a third embodiment;

FIG. 27 is a diagram illustrating one example of a staff profile according to the third embodiment;

FIG. 28 is a diagram illustrating one example of the optimum number of staff members for each job according to the third embodiment;

FIG. 29 is a diagram illustrating one example of a process flow of calculating optimum staff arrangement according to the third embodiment;

FIG. 30 is a diagram illustrating one example of optimum job assignment and a staff arrangement according to the third embodiment;

FIG. 31 is a diagram illustrating one example of transition of predicted productive efficiency in each job according to the third embodiment;

FIG. 32 is a diagram illustrating one example of a screen for job assignment and calculation start according to the third embodiment;

FIG. 33 is a diagram illustrating one example of an output screen for a calculated result according to the third embodiment; and

FIG. 34 is a diagram illustrating one example of a process flow of calculating achievement probability of target productive efficiency of the arrangement plan according to the second embodiment.

### BEST MODE FOR CARRYING OUT THE INVENTION

One example of an embodiment of a staff arrangement system according to embodiments of the present invention is described with reference to figures. Note that the present invention is not limited to the following embodiments.

### First Embodiment

In a first embodiment, staff arrangement for a predicted job amount, that is the number of incoming calls from clients, is planned by calculating productive efficiency based on a skill level of a staff member and a combination with another staff member from a past job log of the staff member in a call center or others.

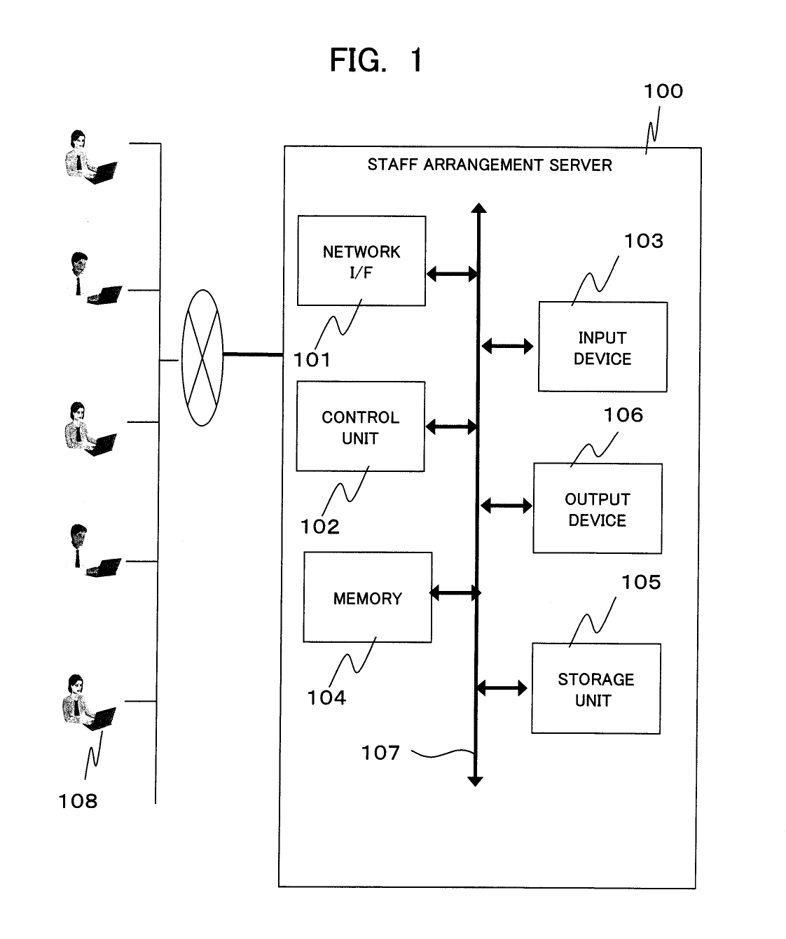

FIG. 1 illustrates one example of a system configuration according to the first embodiment. A staff arrangement server 100 according to the present embodiment includes: a network I/F 101; a control unit 102; an input device 103; a memory 104; a storage unit 105; and an output device 106. They are connected to each other by an internal bus 107, and can mutually transmit and receive data.

The network I/F 101 is, for example, a network card, and collects job logs of staff members constituting a job center through network.

The control unit 102 is mainly configured with a microprocessor, and executes program stored in the memory 104 and the storage unit 105. The input device 103 is, for example, a pointing device such as a key board or a mouse. This accepts instructions or others of input and display for setting an arrangement plan calculation from a job manager. The output device 106 is achieved by, for example, a display adaptor and a liquid crystal panel. The memory 104 is configured with, for example, a random access memory (RAM) or a read only memory (ROM), and stores program executed by the control unit 102, data processed in the server, or others.

The storage unit 105 is configured with, for example, a hard disk, a DVD or CD and its driver, or a non-volatile memory such as a flash memory, and stores program executed by the control unit 102, data processed in the server 100, or others.

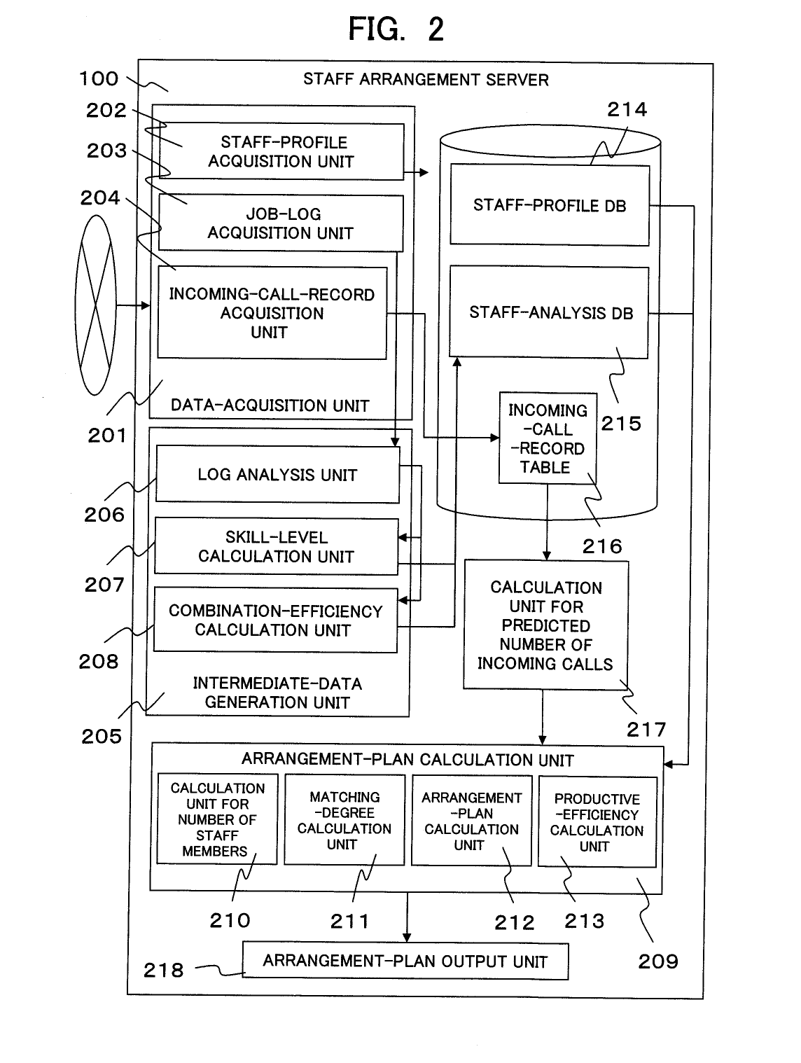

FIG. 2 is one example of a functional block diagram of the staff arrangement server 100. These functional blocks are configured with the program and the data stored in the storage unit 105. Also, the control unit 102 reads the program or the control unit 102 executes the program, reads the data, and performs a calculation process, so that each functional block is achieved as a software module. A part or all of these functional blocks may be configured as a hardware module in addition to a hardware of the staff arrangement server 100 illustrated in FIG. 1. In FIG. 2, the staff arrangement server 100 is configured with: a data acquisition unit 201; an intermediate-data generation unit 205; an arrangement-plan calculation unit 209; a staff-profile database 214; a staff-analysis database 215; an incoming-call record table 216; a calculation unit 217 for the predicted number of times of incoming calls; and an arrangement-plan output unit 218. The data-acquisition unit 201 is a module configured with: a staff-profile acquisition unit 202; a job-log acquisition unit 203; and an incoming-call-record acquisition unit 204. The intermediate-data generation unit 205 is a module configured with: a log analysis unit 206; a skill-level calculation unit 207; and a combination-efficiency calculation unit 208. The arrangement-plan calculation unit 209 is a module configured with: a calculation unit 210 for the number of staff members; a matching-degree calculation unit 211; an arrangement-plan calculation unit 212; and a productive-efficiency calculation unit 213. Note that, in the storage unit 105, a data acquisition program, an intermediate-data generation program, and an arrangement-plan calculation program are stored. Respective programs are handled in the data acquisition unit 201, the intermediate-data generation unit 205, and the arrangement-plan calculation unit. Also, as databases, a staff-profile DB 214, a staff-analysis DB 215, and an incoming-call-record table 216 are stored.

The staff-profile acquisition unit 202 acquires a staff profile such as a name and a working possible hour inputted by each staff member, through network. The acquired staff profile is stored in the staff-profile database 214. The job-log acquisition unit 203 acquires a job log such as a PC operation log, image log, and CTI data of each staff member, through network. The log analysis unit 206 analyzes the acquired job log. From the analyzed result, the skill-level calculation unit 207 calculates a skill level of each staff member, and the combination-efficiency calculation unit 208 calculates combination efficiency with another one or plural staff members. An intermediate data including the combination efficiency generated by the calculation is stored in the staff-analysis database 215. The incoming-call-record acquisition unit 204 acquires records of incoming calls from clients in a PBX 108. The calculation unit 217 for the predicted number of incoming calls calculates the predicted number of future incoming calls from past records of incoming calls. The calculation unit 210 for the number of staff members calculates a working shift and the number of staff members required for the working shift from the calculated predicted number of incoming calls. The matching-degree calculation unit 211 calculates matching degrees of the staff members for one working shift from the staff-profile database 214 and the staff-analysis database 215. The arrangement-plan calculation unit 212 arranges staff members matching each working shift and calculates the arrangement plan. The productive-efficiency calculation unit 213 calculates productive efficiency of the calculated one or each of the plural arrangement plans. The arrangement-plan output unit 218 outputs a staff arrangement plan having the highest productive efficiency as the staff arrangement plan.

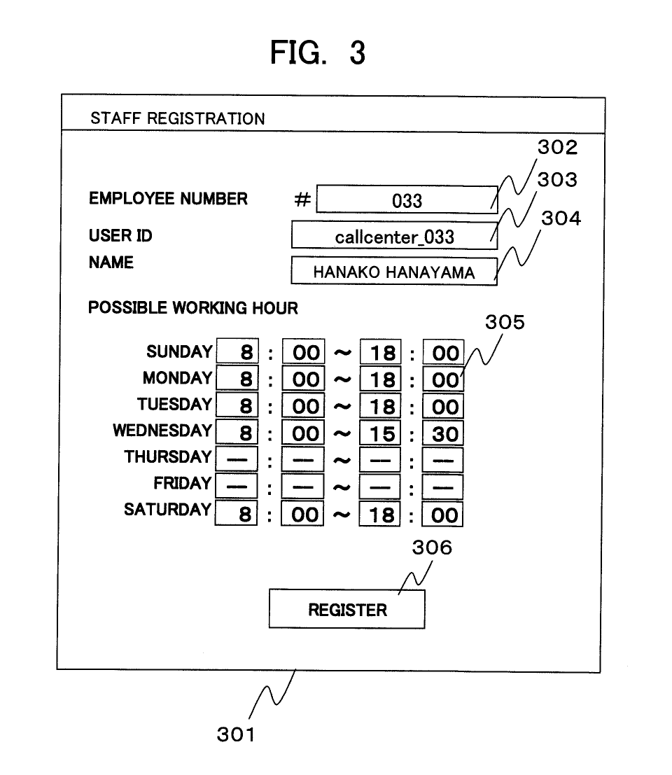

FIG. 3 illustrates one example of a staff registration screen 301 shown on a display unit of a staff member's PC. The registration screen 301 includes input areas for an employee number 302, a user ID 303 of the staff member's PC, a name 304, and a possible working hour 305 of each staff member. These data are inputted from an input device of the staff member's PC to each input area. A registration button 306 is a button of accepting an instruction for sending the input contents to the staff arrangement server 100 through network.

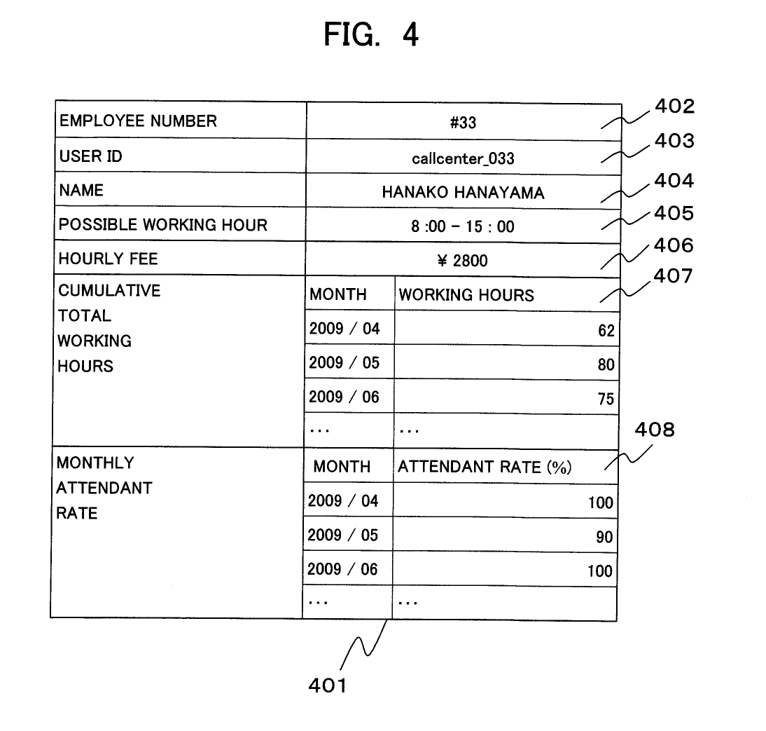

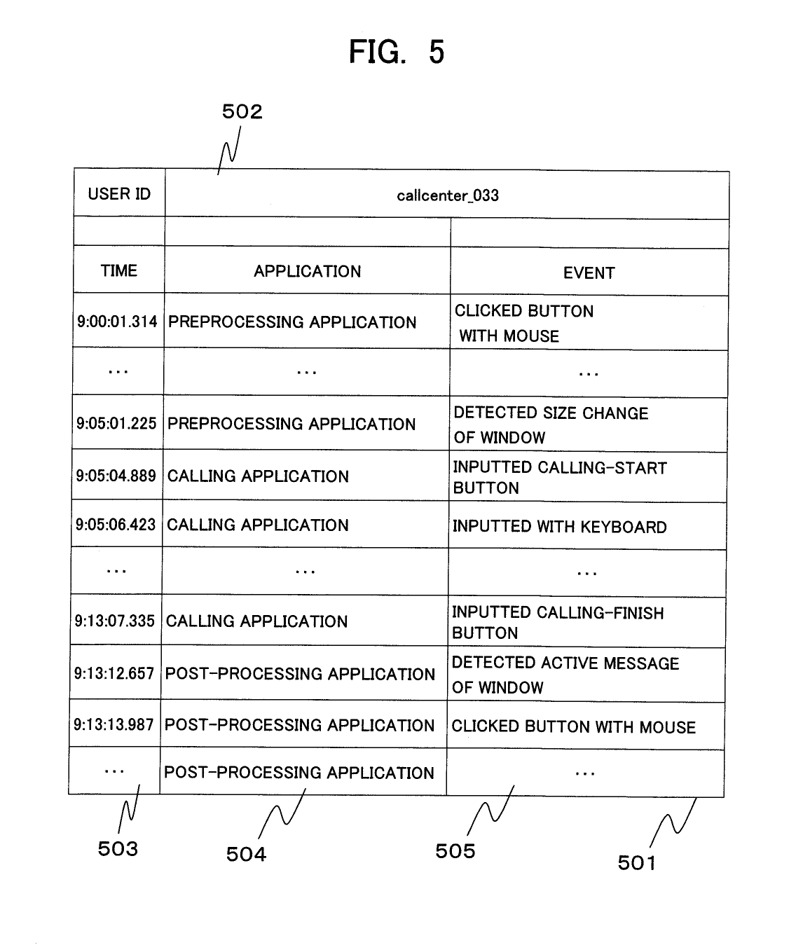

FIG. 4 illustrates one example of a staff profile 401. It illustrates one example of the staff profile 401 generated by receiving the input contents of the staff member. The staff arrangement server 100 receives the input contents of the staff member through the network I/F 101, and stores it in the staff-profile database 214. The control unit 102 receives the input contents by each staff member on the staff registration screen illustrated in FIG. 3, through network with the network I/F 101. The control unit 102 records the input contents on an employee number 402, a user ID 403, a name 404, and a possible working hour 405 in each staff profile 401. Also, the control unit 102 receives input for an hourly fee of each staff member from the manager through the input device 103, and records the input on an hourly fee 406 of each staff member. Further, cumulative total working hours 407 and a monthly attendant rate 408 analyzed from a staff job log described with reference to FIG. 5 are updated in each analysis.

FIG. 5 is one example illustrating a staff member's PC operation log. Note that a staff member's PC operation log 501 is one example of a job log of a staff member. The staff member's PC automatically records the staff member's PC job log by operation of the staff member to the PC operation log. The staff member's PC records a user ID 502 of the staff member, time 503 when an operation is performed, an operated application name 504, and an operated event name 505, in each event. It may record an event in each of used applications. The job log of the staff member may be not only the PC operation log but also an image log pictured by a camera or a sensor log such as a biological sensor or an acceleration sensor. The staff member's PC periodically and automatically sends the operation log of the staff member to the staff arrangement server 100 through network. The sending may be not only periodically and automatically performed but also at any time or when any event such as the instruction input by the staff member or the manager or start of the staff member's PC occurs. The job-log acquisition unit 203 in the staff arrangement server 100 acquires the job log of each staff member through network. The intermediate-data generation unit 205 analyzes the acquired job log and generates staff analysis data, and the data is stored in the staff-analysis database 215.

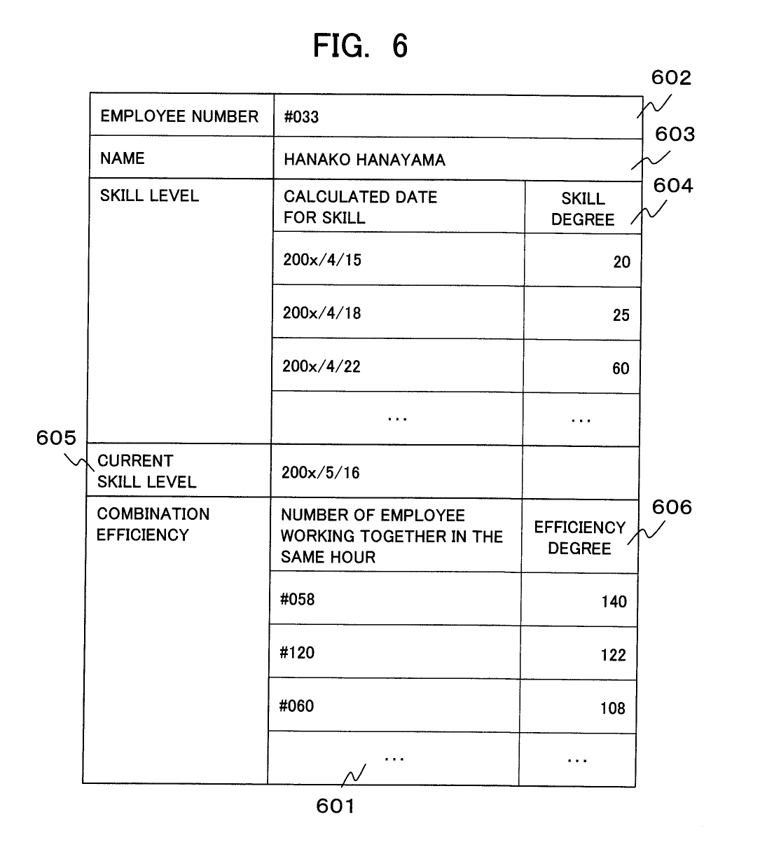

FIG. 6 is one example of a staff-analysis data 601 stored in the staff-analysis database 215, and the staff-analysis data 601 includes: an employee number 602 of the staff member; and a staff member's name 603, and further includes: a skill level 604 on a past working date generated by the intermediate-data generation unit; a current skill level 605 predicted by the calculation from the past skill level; and combination efficiency 606 with another staff member.

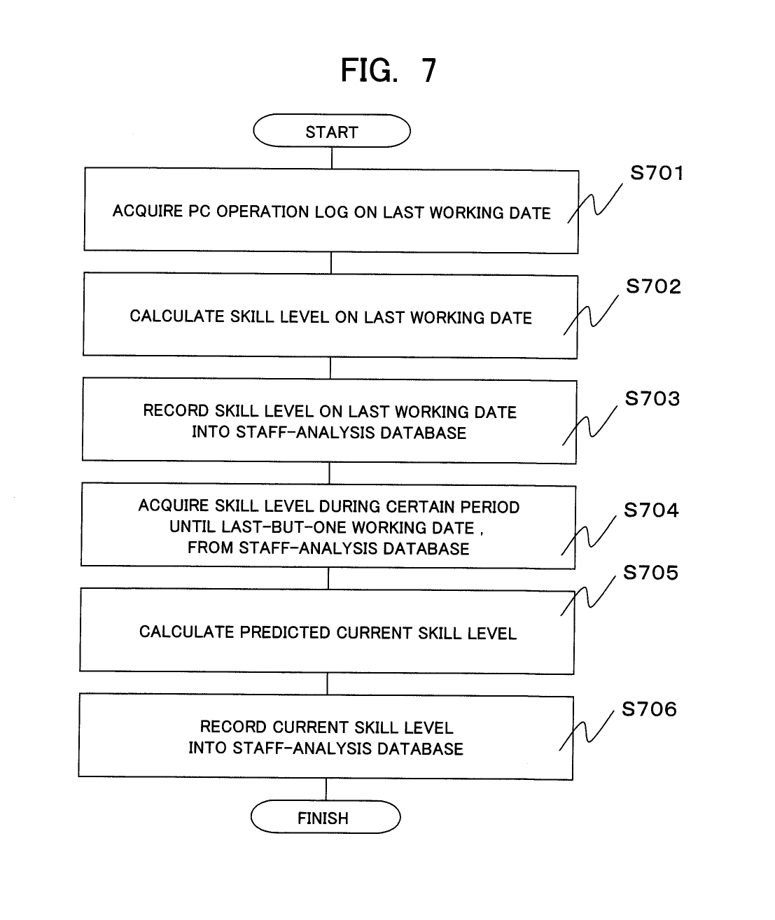

FIG. 7 illustrates one example of a process flow of calculating a skill level from a PC operation log of one staff member. First, a PC operation log 501 on a last working date is acquired (S701), a skill level on the last working date is calculated (S702), and the skill level is recorded into the staff-analysis database 215 (S703). Next, from the staff analysis database 215, a skill level during a certain period until a last-but-one working date is acquired (S704). Here, the certain period may be determined as all periods since a corresponding staff member started to work or previously determined as a period in consideration of the skill level calculation such as the latest 10 working dates. With these manners, the predicted current skill level is calculated from the acquired past skill level until the last working date (S705). The current skill level is recorded into the staff-analysis database (S706).

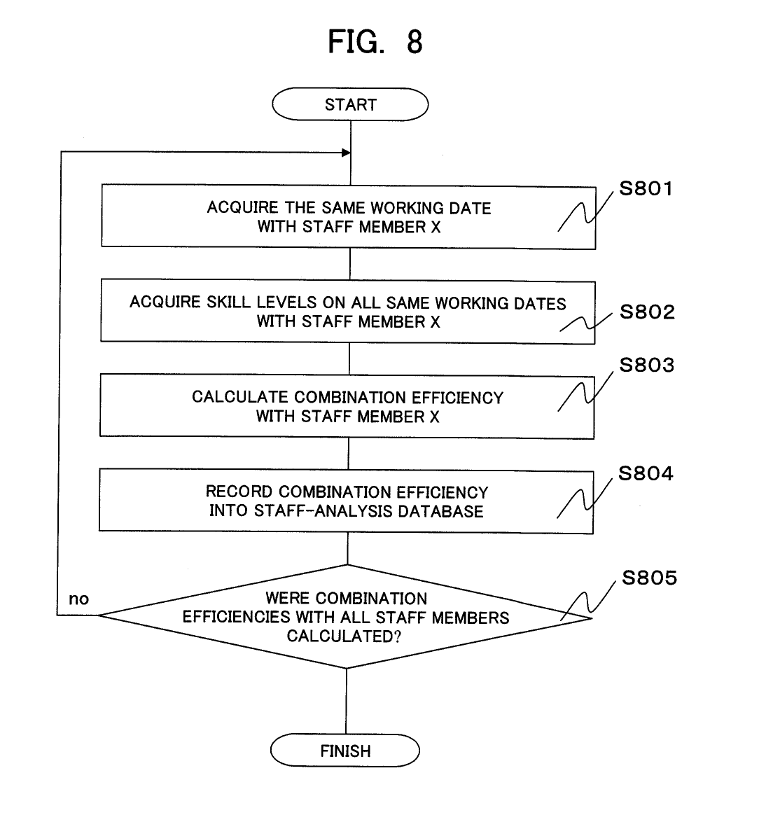

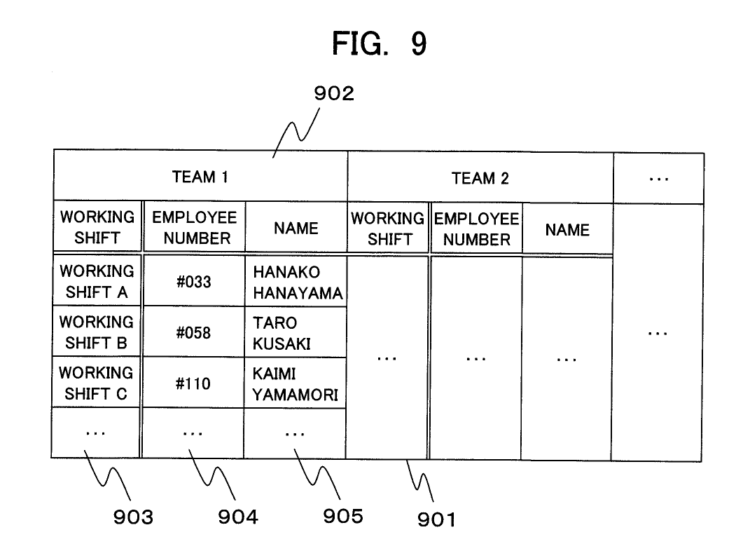

FIG. 8 illustrates one example of a process flow of calculating the combination efficiency of one staff member with another staff member. First, the same working dates with another staff member “X” of all of past working dates are acquired from a team-formation database described with reference to FIG. 9 later (S801), and skill levels of the staff member on all of the same working dates with the staff member X is acquired from the staff-analysis database 215 (S802). Next, the combination efficiency with the staff member X is calculated (S803). The combination efficiency may be, for example, an average value of the skill levels on all of the same working dates of the staff member with the another staff member acquired in S802, or previously determined as a period in consideration of the combination efficiency calculation such as the latest 10 working dates. The combination efficiency is calculated for all of another staff members in each staff member. Alternatively, the combination efficiency may be weighted so that the latest productive efficiency takes the largest part. The calculated combination efficiency is recorded into the staff-analysis database (S804). Until the combination efficiencies with all of the another staff members are calculated, this process is repeated (S805).

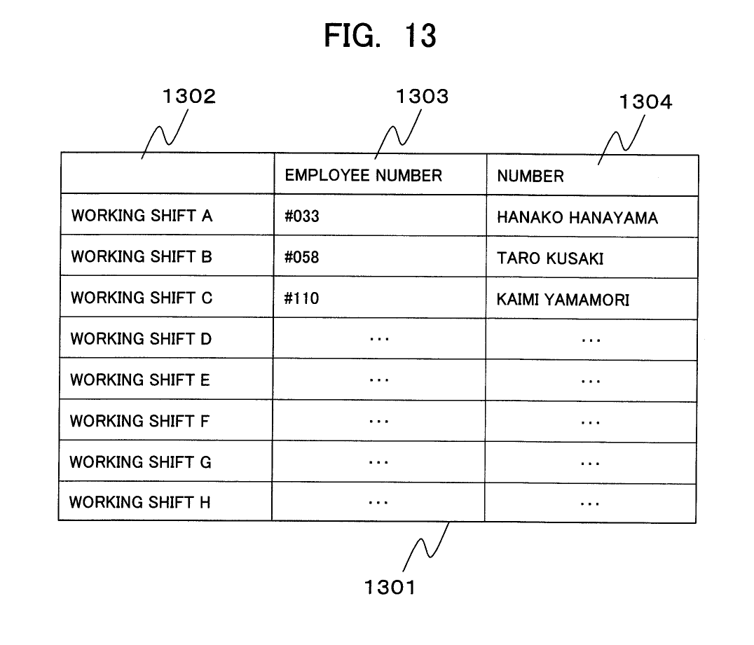

FIG. 9 illustrates one example of a team-formation database for staff members on one working date. The past same working date with one staff member used in the combination efficiency calculation is the same working date in the same team. For example, in a case that a plurality of staff members work together in a call center job, a database 901 for the staff members forming the team which is stored in the memory 104 is appeared. The database for the staff members forming the team is configured with: a team name 902; a working shift 903 described later with reference to FIG. 13; an employee number 904 of a corresponding staff member; and a staff member's name 905. Note that the same working date may be specified in a team in which the staff members cooperatively work together, may be a date when they work or their seats are physically close to each other, or may be specified as related to all staff members when a total number of working staff members is as small as they can communicate with each other. Also, staff members working together in cooperation or job handover may be the staff members forming the same team, such as a staff member assigned for a backyard job and a staff member assigned for a front job or an assigned staff member and a staff member assigned for a management job.

An example of discriminating a skill level from a job amount per unit hour is described. First, from the job log 501, the control unit 102 calculates the number of handling cases completed during a certain unit hour on one working date. For example, a job per one case includes preprocessing, calling, and post-processing, and the number of handling cases is the number of times of appearance of a using log for each of a preprocessing application, a calling application, and a post-processing application. The control unit 102 calculates the skill level on the date from the number of handling cases by a formula 1.

(skill level on specific date)=(number of handling cases on specific date)/(working hours on specific date) [Formula 1]

A skill level on the latest working date may be used as the current skill level, or an average skill level on the latest plural working dates, for example, the latest 10 working dates may be used as the current skill level. The control unit 102 calculates the current skill level by a formula 2 with using the skill level on the specific date which is the calculated result by the formula 1.

$$( current skill level ) = \frac{{\sum }_{n = 1}^{p} ( skill level on n \text{-} th date )}{p} \qquad [ Formula 2 ]$$

Alternatively, for example, in a call center for an outbound job, the skill level may be calculated from not the number of handling cases per unit hour but the number of accepted cases per unit hour.

Alternatively, when the skill level cannot be simply discriminated from the job amount per unit hour since a difference among difficulties of jobs is large or others, the skill level may be higher as job hourly rate is closer to an ideal value. An example of the job hourly rate per case is described. It is assumed that the job per case includes preprocessing, calling, and post-processing. The control unit 102 acquires the using time for each of a preprocessing application, a calling application, and a post-processing application from the job log 501, and calculates ideal values of preprocessing job rate, calling job rate, and post-processing job rate by a formula 3.

$$( preprocessing job rate ) = \frac{( total preprocessing hours )}{\begin{matrix}( total preprocessing hours ) + \\ ( total calling hours ) + \\ ( total post \text{-} processing hours )\end{matrix}} \\ ( calling job rate ) = \frac{( total calling hour )}{\begin{matrix}( total preprocessing hours ) + \\ ( total calling hours ) + \\ ( total post \text{-} processing hours )\end{matrix}} \\ ( post \text{-} processing job rate ) = \frac{( total post \text{-} processing hours )}{\begin{matrix}( total preprocessing hours ) + \\ ( total calling hours ) + \\ ( total post \text{-} processing hours )\end{matrix}} \qquad [ Formula 3 ]$$

The ideal hourly rate is, for example, ideal hourly rate determined and inputted by the manager from the input device 103 and stored in the storage unit 105, or hourly rate of an experienced staff member already known as having high productivity.

Next, a skill level of a target staff member is calculated from the ideal value of each job rate and job rate of the target staff member as expressed by a formula 4. The control unit 102 calculates a skill level of each staff member by the formula 4 with using the ideal value of the hourly rate stored in the storage unit 105 and the hourly rate of each staff member calculated by the formula

$$( skill level ) = 1 - \{ \begin{matrix}{[ \begin{matrix}( preprocessing job rate of staff member ) - \\ ( ideal value of preprocessing job rate )\end{matrix} ]}^{2} + \\ {[ \begin{matrix}( calling job rate of staff member ) - \\ ( ideal value of calling job rate )\end{matrix} ]}^{2} + \\ {[ \begin{matrix}( post \text{-} processing job rate of staff member ) - \\ ( ideal value of post \text{-} processing job rate )\end{matrix} ]}^{2}\end{matrix} \} \qquad [ Formula 4 ]$$

The combination efficiency discriminates a productivity level obtained by the combination with another staff member, and is, for example, a job amount per unit hour in working with the another staff member in the same working hour. The combination efficiency may be required for one specific staff member or plural specific staff members. The combination efficiency with another staff member not having a record of working in the same working hour yet may be not considered, or may take an average value as an initial set value. The skill level and combination efficiency are calculated and updated for the job log of each staff member sent as needed by the intermediate-data generation unit.

A matching degree of the staff member for one working shift is expressed by, for example, a formula 5 from an arrangement priority, a skill level, and a predicted combination efficiency.

The arrangement priority shows, when there are a plurality of workable staff members for one working shift, a priority order by which the staff member is assigned, and the priority order is higher as the arrangement priority is larger. It is assumed that, for example, a staff member having short working hours during a past certain period is preferentially assigned, and the arrangement priority is an inverse number of cumulative total working hours during the past certain period acquired from the working hour record in the staff-analysis data 601. The arrangement priority may be stored in, for example, the storage unit 105.

(matching degree)=(arrangement priority)+(skill level)+(predicted combination efficiency) [Formula 5]

When each element for calculating the matching degree is weighted, the matching degree is expressed by, for example, a formula 6. The weighting coefficients are numbers which are not negative and set by the manager, and are inputted from the input device 103. For example, when the manager requires the assignment so as to focus on the element of the short working hours during the past certain period, the weighting coefficient for the arrangement priority may be increased. When the manager requires to focus on the skill level of individual staff member, the weighting coefficient for the skill level may be increased. When the manager requires to focus on the productive efficiency obtained by the combination with another staff member, the weighting coefficient for the predicted combination efficiency may be increased.

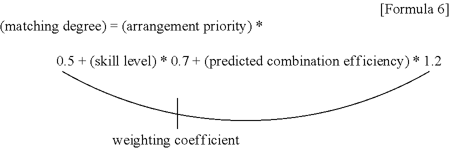

The predicted combination efficiency with the already-arranged plural staff members in the arrangement plan is calculated by, for example, a formula 7 from the combination efficiency in each staff member.

$$( average combination efficiency of p \text{-} th arranged staff member ) = \frac{{\sum }_{n = 1}^{p - 1} ( \begin{matrix}combination efficiency with \\ already \text{-} arranged staff member {}_{}^{``}{n}{}_{}^{″}\end{matrix} )}{( p - 1 )} \qquad [ Formula 7 ]$$

Here, a symbol “p” represents the number of already-arranged staff members. The combination efficiency is effective in a small-scale call center or the like configured with the number of staff members which is as small as they can communicate with each other such as about 10 staff members or less. When a total number of staff members in the same working hour is as large as they cannot communicate with each other such as several tens of staff members, the combination efficiency and the predicted combination efficiency may be calculated by forming the team based on a job type or a physical distance such as a seat position. In this case, an upper limit of “p” may be set in each number of team staff members, and the process may be repeated.

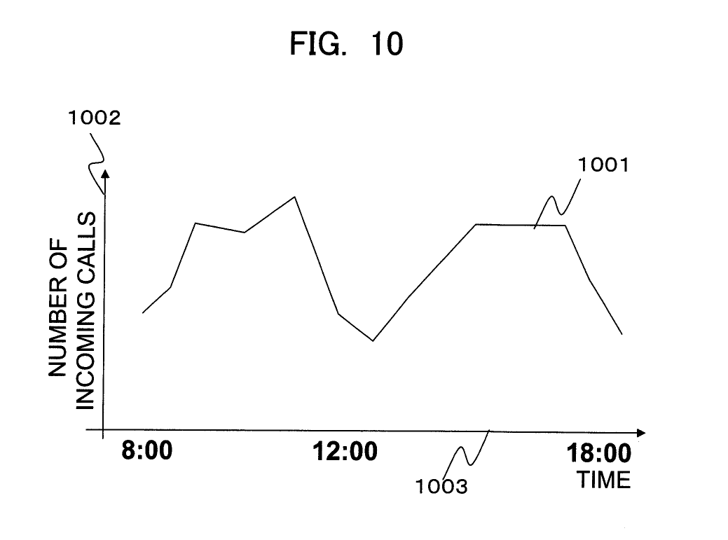

FIG. 10 illustrates one example of predicted transition of the number of incoming calls 1001 from clients. From the past incoming-call record stored in the incoming-call record table 216, the calculation unit 217 for the predicted number of incoming calls predicts transition of the number of incoming calls on a specific date. From the past incoming-call record stored in the incoming-call record table 216, the calculation unit 217 for the predicted number of incoming calls predicts transition of the number of incoming calls on the specific date, and the number of incoming calls 1002 is shown in a vertical axis and the time 1003 is shown in a horizontal axis.

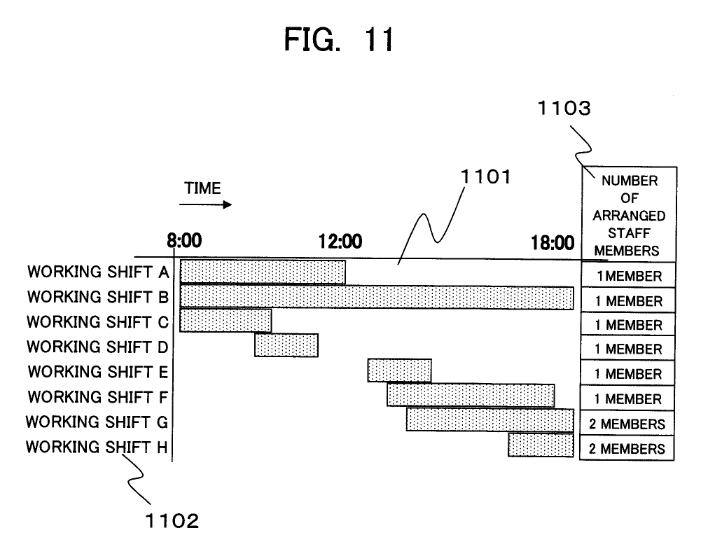

FIG. 11 illustrates the optimum number of staff members calculated by the calculation unit 210 for the number of staff members based on the predicted transition of incoming calls. Each working shift 1102 and the number of staff members 1103 for the working shift are calculated. Next, each specific staff member is arranged to the calculated working shift and the calculated number of staff members for the working shift, so that the staff arrangement is calculated.

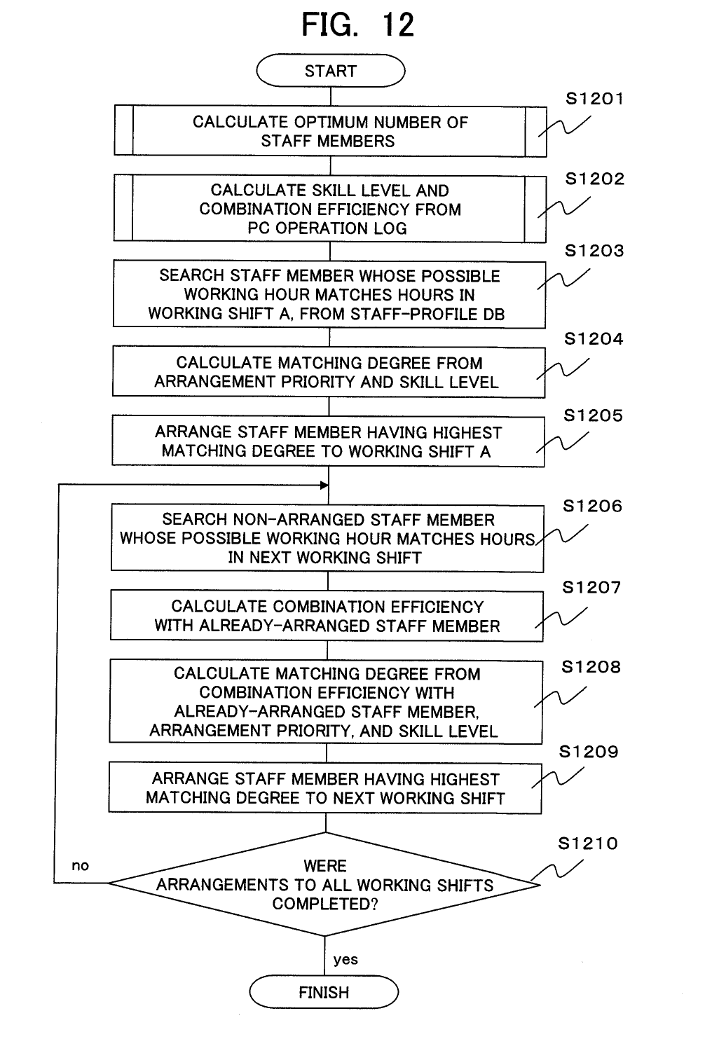

FIG. 12 illustrates one example of a process flow of calculating the staff arrangement. First, the calculation unit 210 for the number of staff members calculates the working shift and the number of staff members corresponding to the predicted number of incoming calls on the specific date such as a date inputted by the job manager from the instruction input device (S1201). The intermediate-data generation unit 205 calculates the skill level of each staff member described with reference to FIG. 7 and the combination efficiency with another staff member described with reference to FIG. 8 (S1202). The matching-degree calculation unit 211 searches a staff member whose possible working hour matches a working shift “A” from the staff-profile DB (S1203), calculates a matching degree of each staff member from the arrangement priority and the skill level (S1204), and arranges a staff member having the highest matching degree to the working shift A (S1205). Sequentially, the process flow is shifted to a second or later working shift, and a staff member who has not been arranged yet and whose possible working hour in the staff profile matches one working shift is searched (S1206). Next, combination efficiency with the plurality of already-arranged staff members is calculated (S1207), and its matching degree is calculated from the combination efficiency, the arrangement priority, and the skill level (S1208). The arrangement-plan calculation unit 212 arranges the staff member having the highest priority to the corresponding working shift (S1209). The staff arrangement is repeated to all working shifts, and when the arrangements are completed to all working shifts (S1210), the process is finished. In the arrangement priority, from the working hour record of the staff analysis data described with reference to FIG. 6, a priority of the staff member having large cumulative total working hours during the past certain period is increased, and is used.

FIG. 13 illustrates one example of an arrangement plan 1301 in which a working staff member is arranged to each working shift. This figure illustrates a working shift 1302 calculated in calculating the optimum number of staff members described with reference to FIG. 12, an employee number 1303 of the staff member arranged so as to correspond to the working shift, and a staff member's name 1304. A plurality of arrangement plans can be calculated by repeatedly calculating the matching degree and arrangement priority in the flow described with reference to FIG. 12 as sequentially lowered. At this time, a limitation for considering health management of the staff member may be provided, in which a staff member whose continuous working dates are 5 or more is removed and the arrangement plan is calculated.

Next, for each arrangement plan, productive efficiency which is an index representing each productivity is calculated. A formula 8 expresses one example of defining the productive efficiency per unit hour of one arrangement plan.

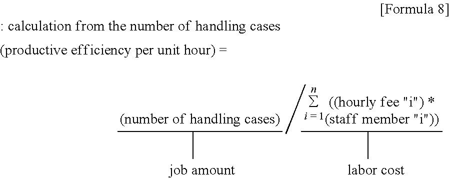

The productive efficiency per unit hour is defined by the number of handling cases of incoming calls from clients and a labor cost required for the cases. An hourly fee is set to be graded on “n” grades each depending on the skill level. A sum-of-product value of the number of staff members each receiving one hourly fee represents a corresponding labor cost per unit hour.

A formula 9 expresses one example of defining the productive efficiency from a rate of the number of handling cases with respect to the number of incoming calls from clients and the labor cost required for the cases.

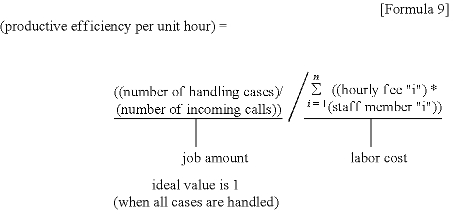

When all cases of incoming calls from clients are handled, a value, that is “the number of incoming calls/the number of handling cases=1”, is an ideal value.

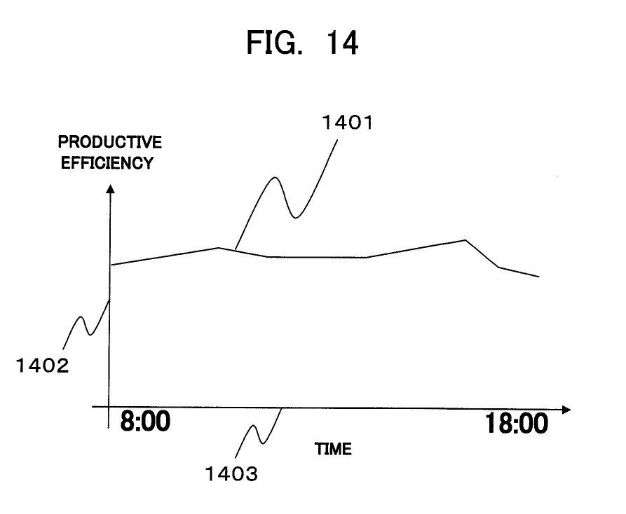

One example of transition of the predicted productive efficiency on one date is illustrated in FIG. 14. A numerical symbol of “1401” indicates one example of the predicted productive efficiency in the optimum staff arrangement, and the productive efficiency 1402 is shown in a vertical axis and the time 1403 is shown in a horizontal axis.

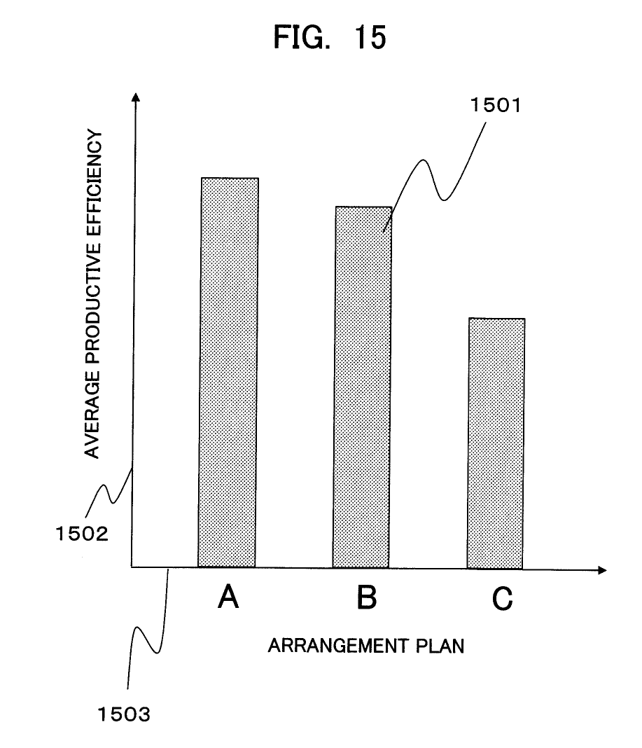

FIG. 15 illustrates one example of averages 1501 of productive efficiencies on one date in the calculated plurality of arrangement plans, and the average productive efficiency 1502 is shown in a vertical axis and the time 1503 is shown in a horizontal axis. The productive efficiency average in each staff arrangement plan is compared to the other, and an arrangement plan having the highest productive efficiency average is shown to the manager as the optimum staff arrangement plan.

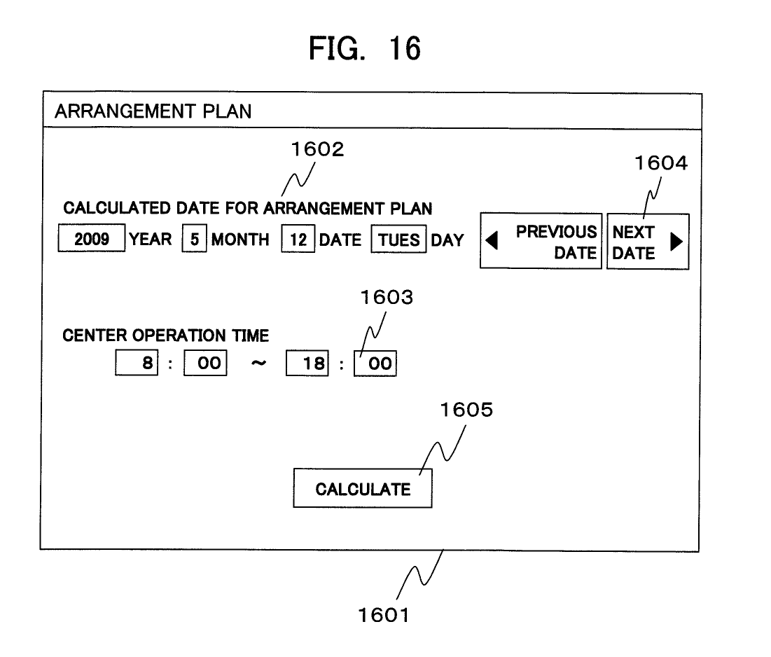

FIG. 16 illustrates one example of an input screen 1601 for starting the arrangement plan calculation displayed on the output device 106 of the present apparatus. The manager inputs an arrangement-plan calculated date 1602 of a target for calculating the arrangement plan and a center operation time 1603 from the input device 103 of the present apparatus. The arrangement-plan calculated date may be changed by a previous/next date button 1604. The control unit 102 starts the arrangement plan calculation under the inputted conditions by a calculation button 1605.

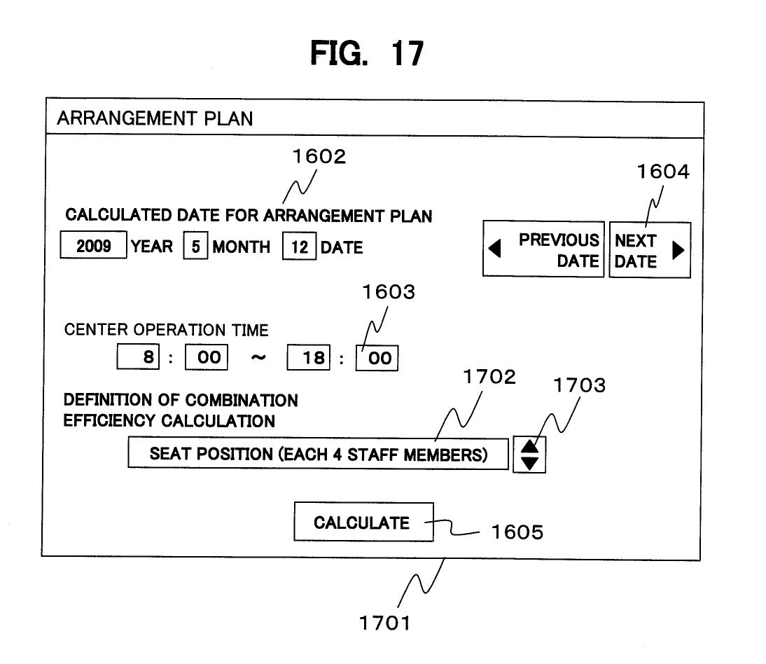

FIG. 17 illustrates one example of an input screen 1701 for starting the arrangement plan calculation when the combination efficiency is limited. The manager inputs conditions for the definition of the combination efficiency calculation into an input column 1702 for the definition of the combination efficiency calculation. By a pull-down menu selection button 1703, previously-prepared conditions may be selected. By inputting the conditions for the definition of the combination efficiency calculation, the combination efficiency calculated when the staff members are arranged is not calculated for all of the another already-arranged staff members but can be calculated only for the staff members whose combinations are important to each other, such as staff members whose seat positions are close to each other or staff members who are assigned for the same job.

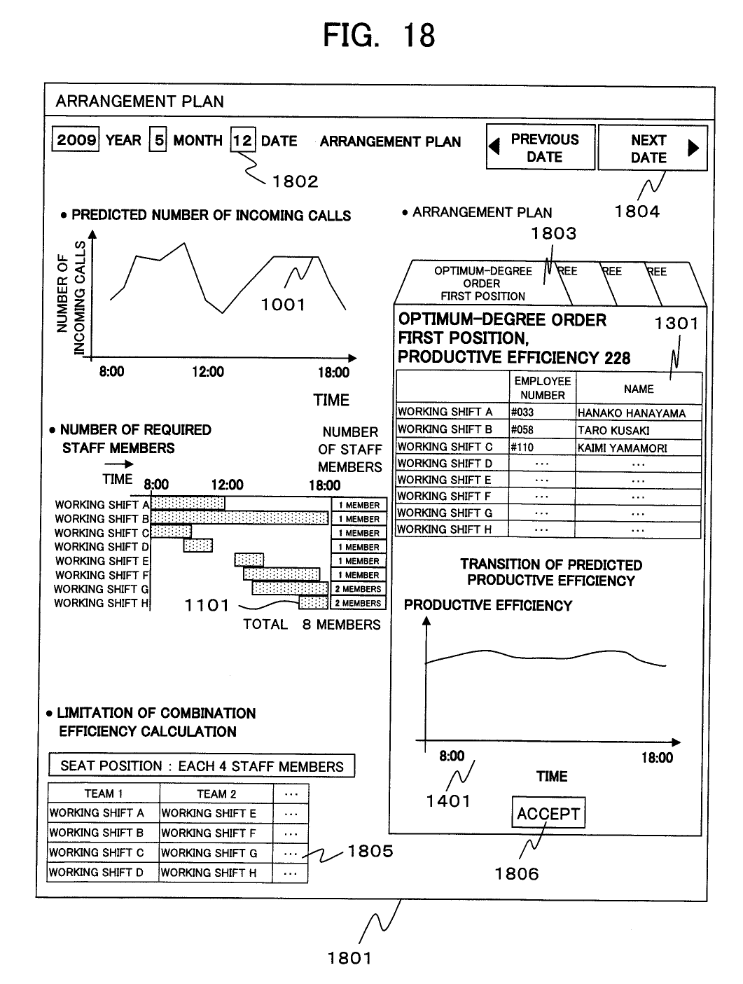

FIG. 18 illustrates one example of an output screen 1801 for a result of the arrangement plan calculation displayed on the output device 106 of the present apparatus. When the arrangement plan calculation under the inputted conditions is completed, the control unit 102 displays the output screen 1801 for the result of the arrangement plan calculation. The output screen 1801 shows the date 1802 of the corresponding arrangement plan, the prediction 1001 for the number of incoming calls described with reference to FIG. 10, and the optimum number of staff members 1101 described with reference to FIG. 11. The specific date may be changed by a previous/next date button 1804. Also, the staff arrangement plan having the highest productive efficiency is put on a first position in an optimum-degree order, and the staff arrangement plan 1001 and the predicted transition of the productive efficiency 1401 are sequentially displayed in the optimum-degree order. The staff arrangement plan may be switched to be displayed by an optimum-degree-order display tab menu 1803. Further, when the combination efficiency is calculated only for the staff members whose combinations are important to each other, such as staff members whose seat positions are close to each other or staff members who are assigned for the same job, a condition 1805 for the combination efficiency calculation such as a combination-limit calculation based on the seat position may be displayed.

By pressing an acceptance button 1806, a staff arrangement plan accepted from the plurality of staff arrangement plans is determined. In this manner, the accepted arrangement plan may be noticed by sending it to a client PC or others of the staff member through network and displaying it.

After the job on the date when the arrangement plan is accepted is finished, a daily report showing a difference between the predicted and actual accepted results may be displayed. Also, by an instruction of the manager, a daily report on a specific past date may be displayed.

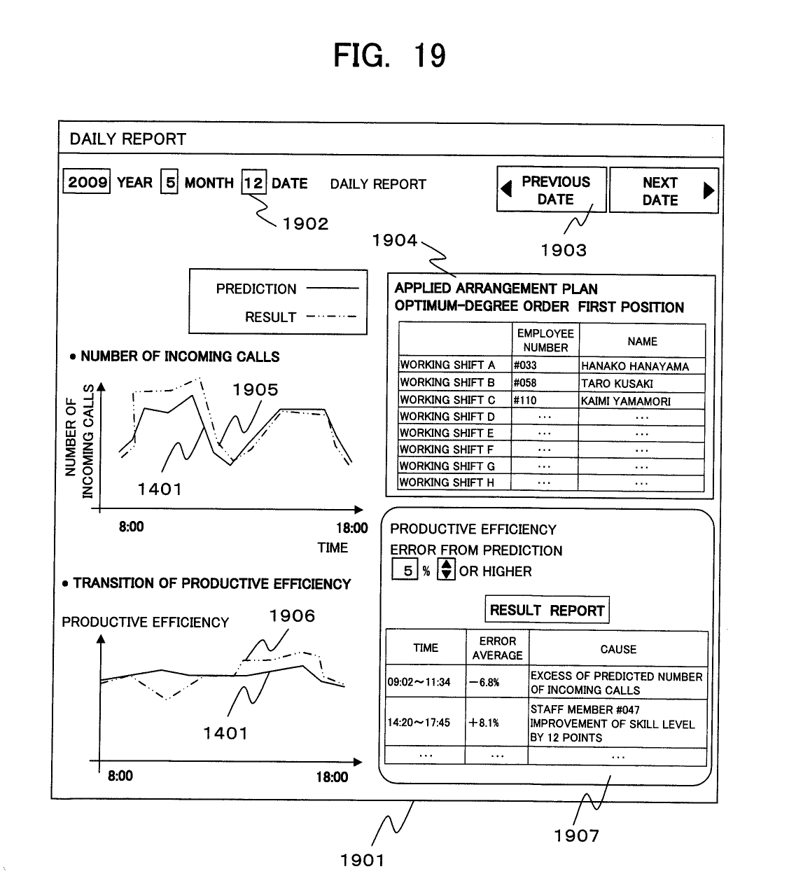

FIG. 19 illustrates one example of an output screen 1901 for the daily report displayed on the output device 106 of the present apparatus. After the job on the date when the arrangement plan is accepted is finished, the daily report may be displayed or the daily report of the specific past date by the manager may be displayed. In the daily report 1901, the predicted number of incoming calls 1001 and the predicted transition of productive efficiency 1401 are compared with their results when the staff members are actually arranged based on the accepted staff arrangement plan 1904, and the comparison is displayed. The corresponding date 1902 when the daily report is made may be changed by a previous/next date button 1903. The result 1905 for the number of incoming calls indicates a comparison of the predicted number of incoming calls 1001 with the actual number of incoming calls. The productive-efficiency transition 1906 indicates a comparison of the transition 1401 of the predicted productive efficiency with the actual transition of the productive efficiency. The difference between the prediction and the result may be outputted as the result report 1907. For example, items being causes of the difference are databased, and the hour having the difference of a constant rate or higher between the prediction and the actual result is outputted, and then, a most-affecting item for the difference and a numerical value of the item may be displayed.

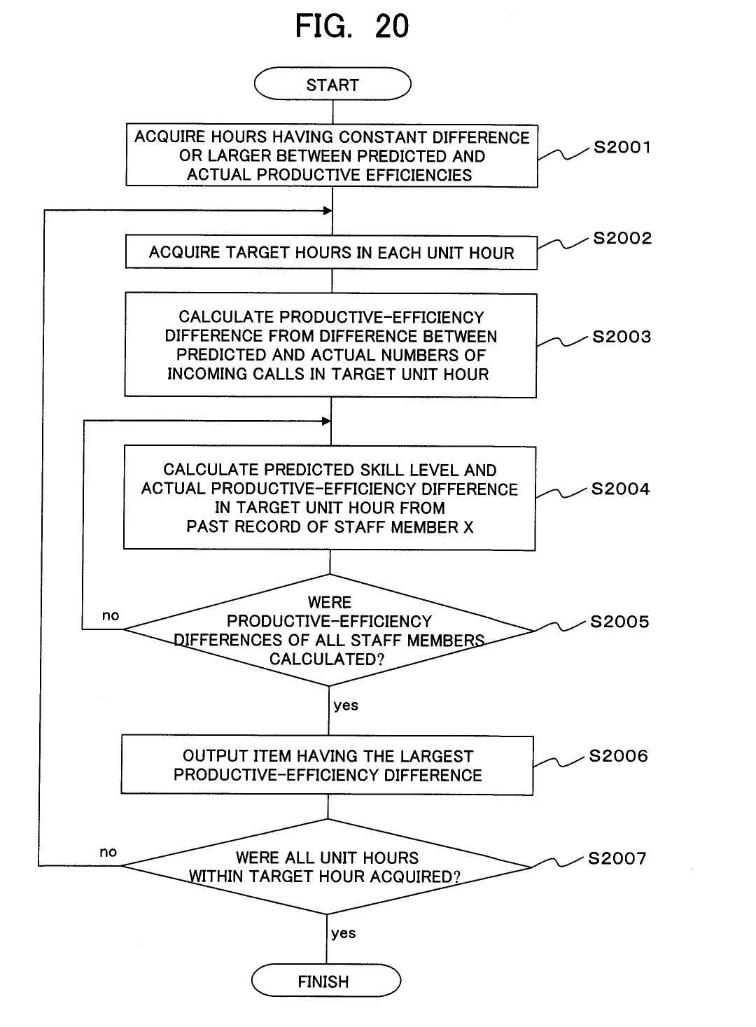

FIG. 20 illustrates one example of a process flow of calculating the most-affecting item for the difference between the predicted productive efficiency and its result. First, the control unit 102 acquires the hours each having the difference of the constant rate or higher between the prediction and the actual result (S2001), and acquires the hours in each unit hour (S2002). Next, from a difference between the predicted number of incoming calls in a target unit hour and its actual number of incoming calls, a productive-efficiency difference is calculated (S2003). Next, from a past record of one staff member, a predicted skill level thereof and actual productive efficiency thereof in the target unit hour are calculated (S2004). The actual productive-efficiency differences of all staff members in the target unit hour are calculated (S2005), and the efficiency having the largest productive-efficiency difference is outputted as the most-affecting item for the difference in the target unit hour (S2006). All unit hours in the hours each having the difference of the constant rate or higher between the prediction and the actual result are acquired and processed (S2007), and the process is finished.

### Second Embodiment

In a job in a call center or the like, there is a risk of a small productive efficiency due to staff-member absence such as work absence of the staff member. For example, the data such that an absent rate is high before and after a holiday or others can be acquired from a past attendant record, and therefore, decrease of the productive efficiency is considered from the data. In a second embodiment, in the call center or the like, the member-absent risk is calculated by calculating the attendant rate from the past attendant record of the staff member in additional to the calculations of the skill level from the past job log of the staff member and the productive efficiency obtained by the combination with another staff member, so that optimum staff arrangement is planned.

The second embodiment is achieved by the hardware configuration illustrated in FIG. 1 and the software configuration illustrated in FIG. 2 similarly to the first embodiment.

First, in one arrangement plan, the attendant rate of each arranged staff member is calculated. The attendant rate that one staff member is not absent and normally attendant can be calculated from, for example, the past attendant record. One example of the calculation of the attendant rate is expressed by a formula 10.

$$( attendant rate ) = \frac{( \begin{matrix}actual number of \\ attendant dates\end{matrix} )}{( \begin{matrix}predicted number of \\ attendant dates\end{matrix} )} \qquad [ Formula 10 ]$$

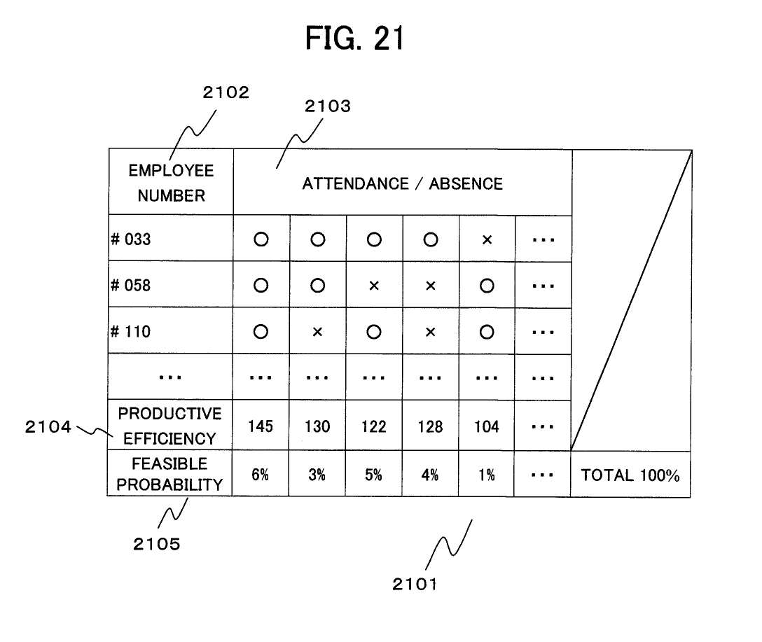

FIG. 21 is one example illustrating a member-absent-risk prediction 2101 in one arrangement plan. In an employee number 2102 of the arranged staff member, there is provided an attendant state that attendance/absence states are shown with a circle in an attendant column 2103 in the attendance and a cross therein in the absence. Also, there are provided productive efficiency 2104 and a feasible probability 2105 in the attendant state. A total number of the attendant states is expressed as “2 to the power of n number” when a total number of the arranged staff members is taken as “n”. The feasible probability in the attendant state is calculated from product of the attendant rates of the attendant staff members. When the total number of the arranged staff member is taken as “n”, one example of the calculation of the achievement probability in the attendant state is expressed by a formula 11.

$$( feasible probability ) = {\prod }_{k = 0}^{n} ( \begin{matrix}attendant rate of \\ staff member {}_{}^{``}{k}{}_{}^{″}\end{matrix} ) \qquad [ Formula 11 ]$$

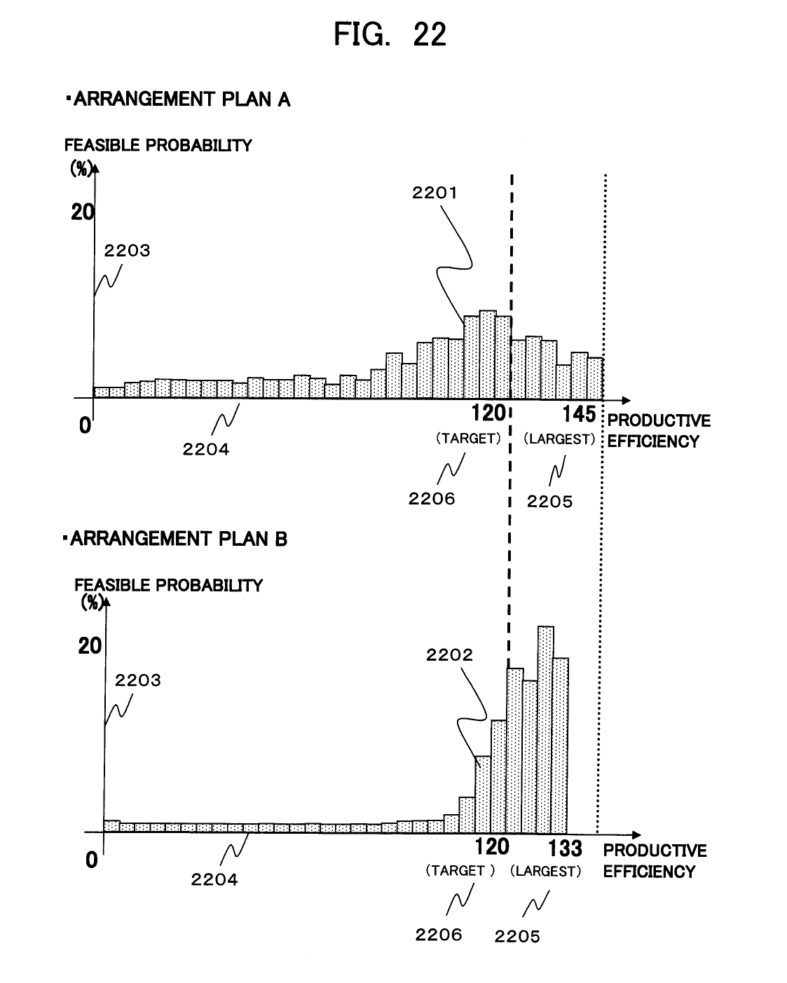

FIG. 22 illustrates an example of a diagram illustrating a feasible probability of actualizing one productive efficiency in a specific arrangement plan. There are provided, for example, a feasible probability 2201 of a productive efficiency in an arrangement plan “A” and a feasible probability 2202 of a productive efficiency in an arrangement plan “B”. The productive efficiency 2204 is taken in a horizontal axis and the feasible probability 2203 is taken in a vertical axis, and the most right portion shows the largest productive efficiency 2205 when all of the arranged staff members are attendant. When a target productive efficiency 2206 required by the manager is taken as, for example, 120, a comparison of each feasible probability with the other is described. A probability of achieving the target productive efficiency or larger is expressed by summation of the feasible probabilities, that is summation of the feasible probabilities from the target productive efficiency to the largest productive efficiency. When the feasible probability 2201 in the productive efficiency “x” is taken as “f(x)”, one example of defining an achievement probability of the target productive efficiency is expressed by a formula 12.

$$( achievement probability ) = {\sum }_{x = target productive efficiency}^{largest productive efficiency} f ( x ) \qquad [ Formula 12 ]$$

Also, a non-achievement probability in which the target productive efficiency is not achieved may be shown to the manager. The non-achievement probability is expressed by summation of the feasible probabilities from the productive efficiency of 0 to the target productive efficiency. One example of calculating a non-achievement risk probability is expressed by a formula 13.

$$( non \text{-} achievement risk ) = {\sum }_{x = 0}^{target productive efficiency} f ( x ) \qquad [ Formula 13 ]$$

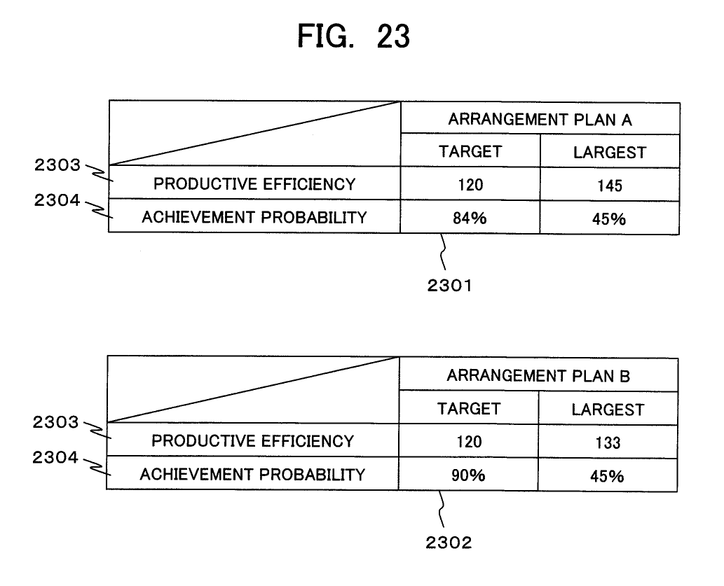

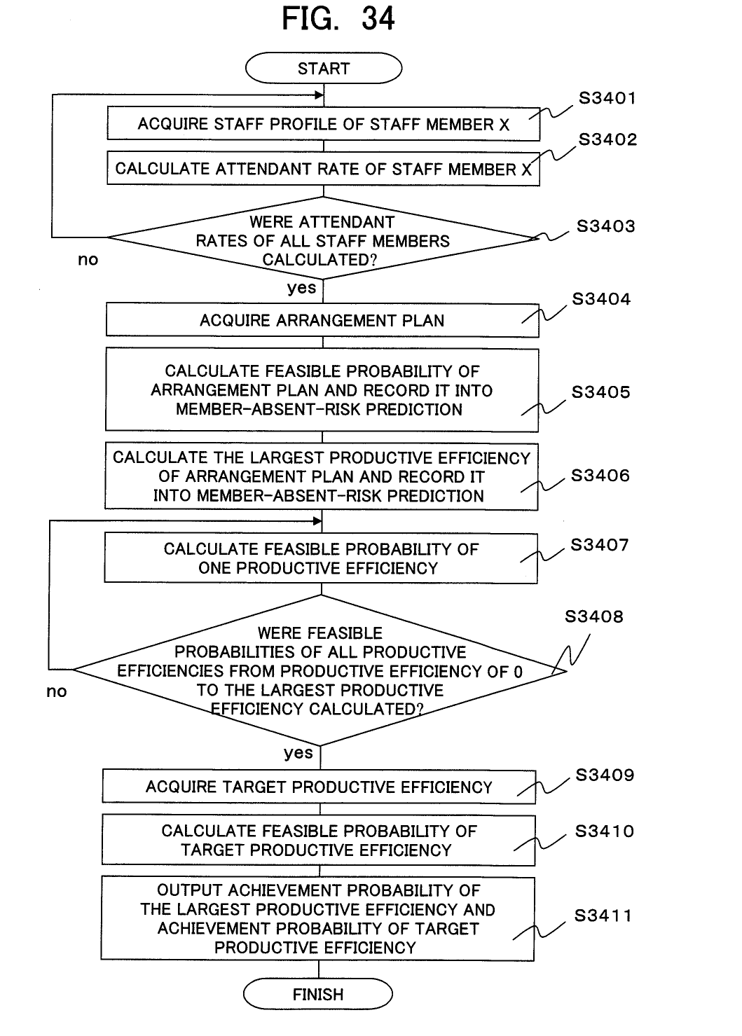

FIG. 34 illustrates one example of a process flow of calculating the achievement probability of the target productive efficiency, which shows the member-absent risk in one arrangement plan according to the second embodiment. First, the control unit 102 acquires a staff profile 401 (S3401), and calculates the attendant rate of the staff member X (S3402). The attendant rates of all of the staff members are calculated (S3403), so that the arrangement plan 1301 calculated in the first embodiment is acquired (S3404). From the acquired arrangement plan, the feasible probability in the arrangement plan is calculated, and is recorded into the member-absent-risk prediction 2101 (S3405). Also, the largest productive efficiency in the arrangement plan is calculated, and is recorded into the member-absent-risk prediction (S3406). Next, from the feasible probability in each arrangement plan recorded in the member-absent-risk prediction, the feasible probability of one productive efficiency is calculated (S3407). Note that FIG. 22 illustrates the feasible probability of each productive efficiency. By calculating the feasible probabilities of all of the productive efficiencies from the productive efficiency of 0 to the largest productive efficiency (S3408), the target productive efficiency inputted by the manager from the input device 103 and stored in the storage unit 105 is acquired (S3409). The achievement probability of the target productive efficiency is calculated (S3410), and the output device 106 outputs the achievement probability of the largest productive efficiency and the achievement probability of the target productive efficiency (S3411). The outputting is performed with, for example, formats illustrated in FIGS. 23, 24, and 25 described later.

FIG. 23 illustrates an example of a diagram illustrating the achievement probabilities of the largest productive efficiency and the target productive efficiency. There are provided, for example, an achievement probability 2301 in the arrangement plan A and an achievement probability 2302 in the arrangement plan B. For each of the target and largest productive efficiencies 2301, an achievement probability 2304 is shown. In the present embodiment in consideration of the member-absent risk, an optimum degree of an arrangement plan having a high achievement probability of not the largest productive efficiency but the target productive efficiency is increased, and the arrangement plan becomes an optimum staff arrangement plan.

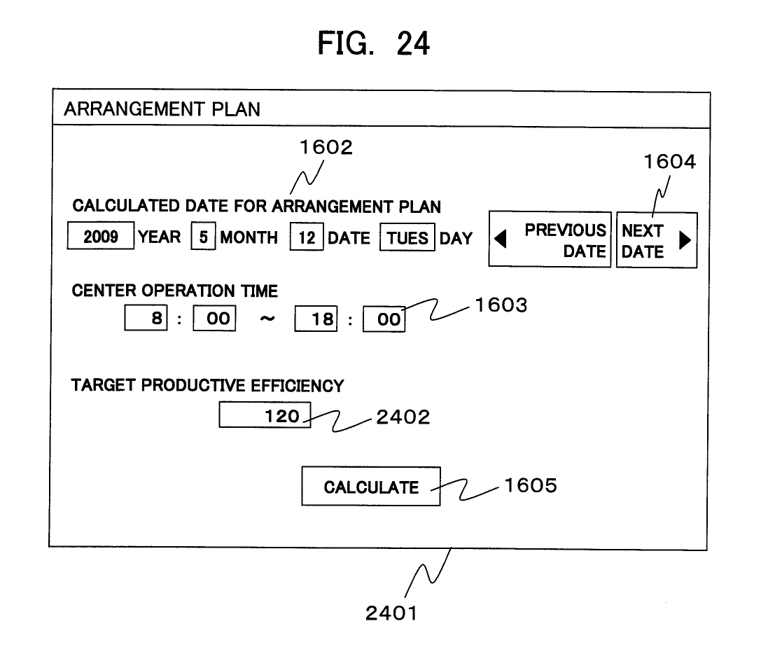

FIG. 24 illustrates one example of an input screen 2401 for starting the arrangement plan calculation to which the member-absent risk is added, displayed on the output device 106 of the present apparatus. The manager inputs an arrangement-plan calculated date 1602 of a target for calculating the arrangement plan and a center operation time 1603 from the input device 103 of the present apparatus. The arrangement-plan calculated date may be changed by a previous/next date button 1604. Also, in a target productive efficiency input column 2402, the target productive efficiency is inputted. By pressing a calculation button 1605, the control unit 102 starts the calculation of the arrangement plan under the inputted conditions.

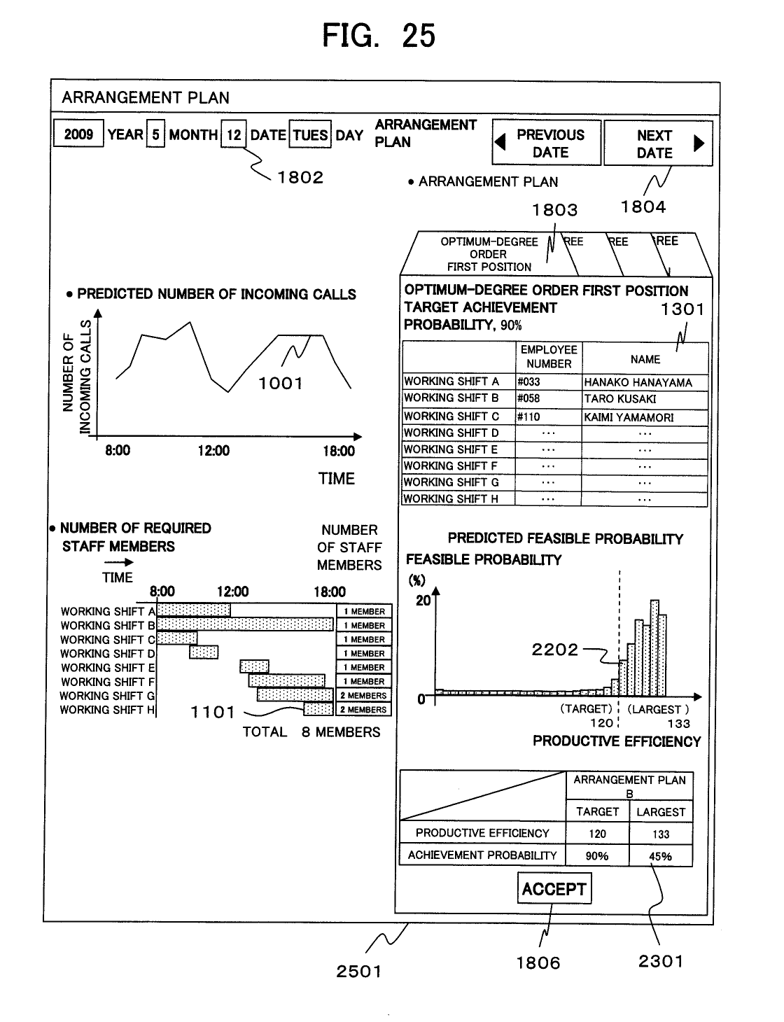

FIG. 25 illustrates one example of an output screen 2501 for a result of the arrangement plan calculation to which the member-absent risk is added, displayed on the output device 106 of the present apparatus. When the calculation of the arrangement plan under the inputted conditions is completed, the control unit 102 displays the output screen 2501 for the result of the arrangement plan calculation on the output unit 106. The output screen 2501 shows a date 1802 of the corresponding arrangement plan, the prediction 1001 of the number of incoming calls described with reference to FIG. 10, and the optimum number of staff members 1101 described with reference to FIG. 11. The specific date may be changed by a previous/next date button 1804. Also, the staff arrangement plan having the highest productive efficiency is put on a first position in an optimum-degree order, and the staff arrangement plan 1301 is sequentially displayed in the optimum-degree order. The staff arrangement plan 1301 may be switched to be displayed by an optimum-degree-order display tab menu 1803. In the arrangement plan, the corresponding arrangement plan 1301, the predicted feasible probability 2202, and the achievement probability 2301 are shown. By pressing an acceptance button 1806, the accepted staff arrangement plan is determined from the plurality of staff arrangement plans. In this manner, the accepted arrangement plan may be noticed by sending it to a client PC of the staff member through network or others and displaying it.

### Third Embodiment

In a third embodiment, when a plurality of different jobs are generated in a call center or the like, an optimum staff arrangement is planned for each of predicted job amounts by calculating a skill level of one staff member from each of a plurality of past job logs thereof and a productive efficiency thereof obtained by a combination with another staff member.

The third embodiment is achieved by the hardware configuration illustrated in FIG. 1 and the software configuration illustrated in FIG. 2 similarly to the first embodiment.

First, a staff member's PC automatically records a job log of the staff member's PC operated by the staff member into a PC operation log similarly to the first embodiment. The staff member's PC records a user ID 502 of the staff member, time 503 in one operation, and an operation event name 505 in each event. The job log of the staff member may be not only a PC operation log but also an image log pictured by a camera or a sensor log such as a biological sensor or an acceleration sensor. The staff member's PC periodically and automatically sends the staff operation log to the present apparatus through network. The sending may be not periodically and automatically performed but performed at any time or performed when any event such as the instruction input or start of the staff member's PC by the staff member or the manager occurs. The job-log acquisition unit 203 in the present apparatus acquires the job log of each staff member through network. The intermediate-data generation unit 205 analyzes the acquired job log and generates staff analysis data, and the data is stored in the staff-analysis database 215.

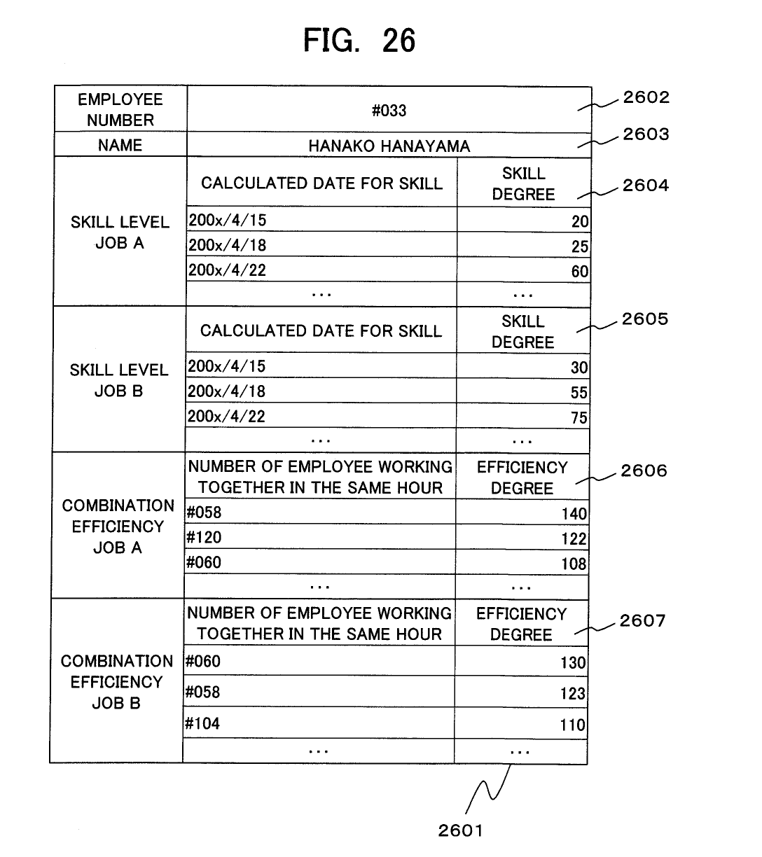

FIG. 26 is one example of a staff analysis data 2601 stored in the staff-analysis database 215. The staff analysis data 2601 includes: an employee number 2602 of the staff member; and a staff member's name 2603, and includes: a skill level/job A 2604 and a skill level/job B 2605, which are a plurality of different jobs such as respective jobs A and B; a combination efficiency/job A 2606 with another staff member; and a combination efficiency/job B 2607 therewith.

The skill level is similarly calculated by the formula 1 in the first embodiment, and is calculated from the job amount which can be completed, for example, within the certain unit hour of the job log.

The combination efficiency discriminates a productive level obtained by the combination with another staff member, and is, for example, a job amount per unit hour when the staff member works with another staff member in the same working hour. The combination efficiency may be required for specific one staff member or specific plural staff members. The combination efficiency with another staff member not having a record of the work in the same working hour yet may be not considered, or an initial set value of the combination efficiency may be an average value. The skill level and the combination efficiency are calculated by the intermediate-data generation unit as needed for the job log of each staff member sent as needed, and are updated.

Further, similarly to the first embodiment, the matching degree of the staff member and the combination efficiency thereof are calculated.

Next, from a past incoming-call record in each job stored in the incoming-call-record table 216, the calculation unit 217 for the predicted number of incoming calls predicts transition of the number of incoming calls on the specific date. For example, it is assumed that two types of incoming calls of an incoming call for a job “A” and an incoming call for a job “B” are caused.

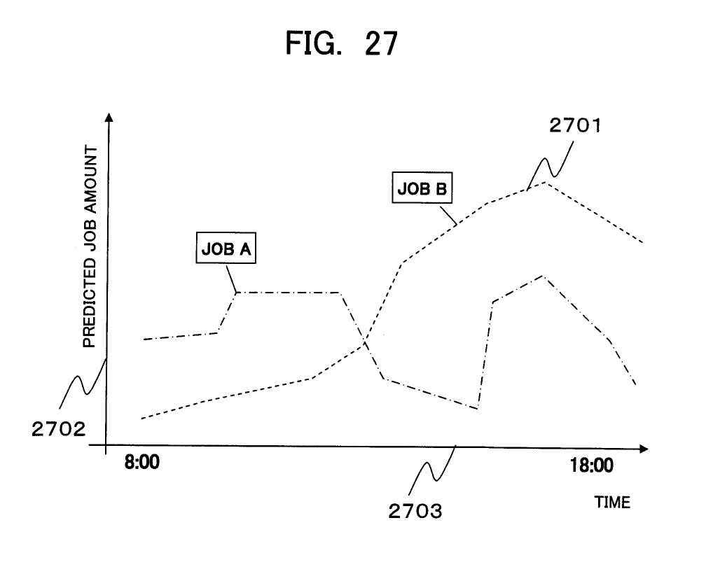

FIG. 27 is one example of the incoming-call transition prediction 2701 in each job, and a job amount 2702, that is the number of incoming calls in a call center, is shown in a vertical axis and time 2703 is shown in a horizontal axis. From the past incoming-call record stored in the incoming-call-record table 216, the calculation unit 217 for the predicted number of incoming calls predicts transition of the number of incoming calls in each job on the specific date. One example of the prediction of the transition of the number of incoming calls for each of the job A and the job B from clients is described.

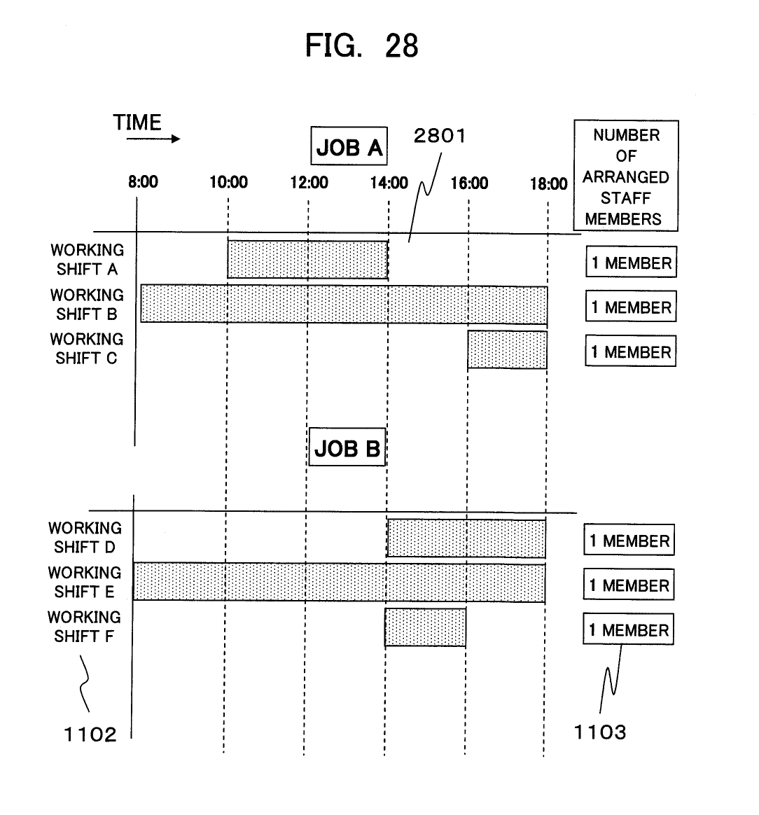

FIG. 28 illustrates the optimum number of staff members 2801 in each job, which is calculated by the calculation unit 210 for the number of staff members based on the incoming-call transition prediction. The number of staff members in each job is varied in each shift unit hour, for example, each two hours as a minimum unit. Each working shift 1102 and the number of staff members 1103 for the working shift are calculated. Next, each of specific staff members is arranged to the working shift in each job and the optimum number of staff members for the working shift calculated in each shift unit hour, so that the optimum staff arrangement is calculated. At this time, since the jobs are assigned in each shift unit hour as the minimum unit, the productive efficiency is improved by changing the assigned job for one staff member in each shift unit hour.

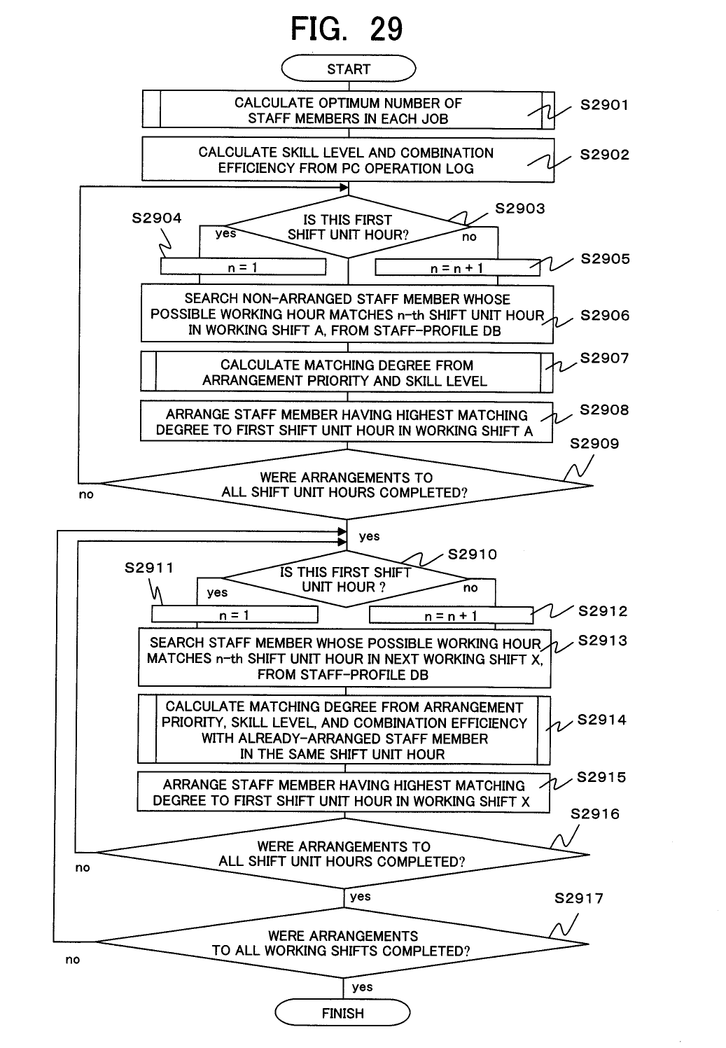

FIG. 29 illustrates one example of a process flow of calculating the optimum staff arrangement when the plurality of different jobs are caused. First, the calculation unit 210 for the number of staff members calculates the optimum number of staff members in each job (S2901). The intermediate-data generation unit 205 calculates the skill level and the combination efficiency from the job log (S2902), and stores them in the staff-analysis database. Next, when the assignment is for a first shift unit hour in the working shift A which is a first working shift (S2903), a relation of “n=1” is taken (S2904), and a staff member whose possible working hour matches the first shift unit hour in the working shift A is searched from the staff-profile DB (S2906). A matching degree is calculated from an arrangement priority and a skill level of the matched staff member (S2907), and the staff member having the highest matching degree is arranged to the first shift unit hour in the working shift A (S2908). At this time, a skill level for handing the job in the corresponding working shift, for example, a skill level/job A corresponding to the job A is used as the skill level. Until the arrangements to all shift unit hours in the working shift A are completed (S2909), “n” is increased by one (S2905) for repeatedly arranging, and the arrangements in the working shift A are completed. Next, an arrangement is performed to a first shift unit hour in a next working shift “X”. When the assignment is for the first shift unit hour (S2910), a relation of “n=1” is taken (S2911), and a staff member whose possible working hour matches the first shift unit hour in the working shift X is searched from the staff profile DB (S2913). A matching degree is calculated from an arrangement priority and a skill level of the matched staff member and a combination efficiency with the staff member already arranged to another working shift in the same working shift hour (S2914), and the staff member having the highest matching degree is arranged to the first shift unit hour in the working shift X (S2915). Until the arrangements to all shift unit hour in the working shift X are completed (S2916), “n” is increased by one (S2912) for repeatedly arranging, and the arrangements to the working shift X are completed. Similarly, until the arrangements to all working shifts are completed (S2917), the process is repeatedly performed, and the arrangements to all shift unit hours in all working shifts are completed.

When the arrangements for assigning the plurality of jobs are planned, if decrease of the productive efficiency or burden to the staff member due to the assignments is caused, the assignments may be limited. For example, when the assignment of the staff member is changed from the job A to the job B in the working on the same date, if it is concerned that preparation or movement for the change takes time or the productive efficiency is decreased due to the burden to the staff member caused by the plural number of times of job change, the number of times of job change on the same date may be limited up to once, and the arrangement plan may be calculated. Also, in order to avoid arranging the staff member so as to step over hours on the same date such that the staff member is arranged to the first shift unit hour, and after four free hours, arranged to another shift unit hour on the same date, there may be provided a limitation such that the staff member is arranged only to continuous shift unit hours, and the arrangement plan may be calculated.

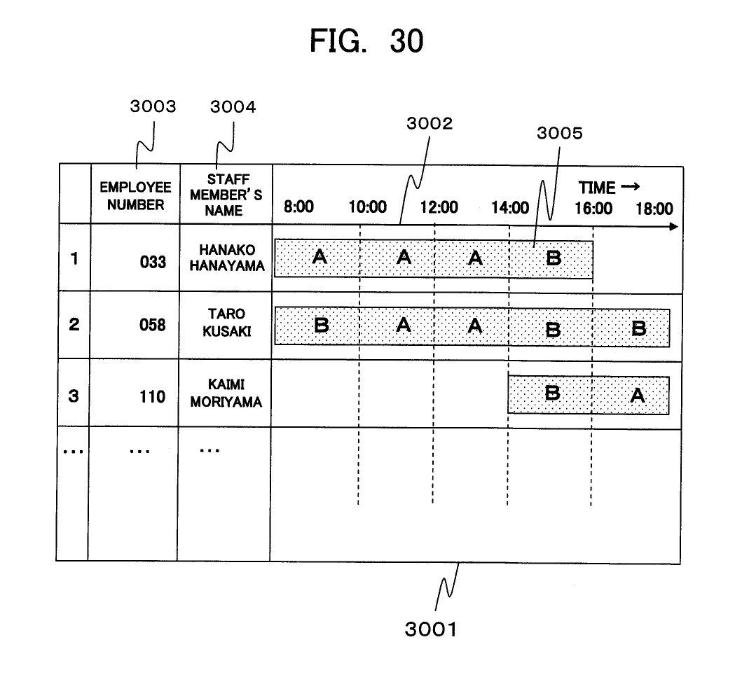

FIG. 30 illustrates one example of an arrangement plan 3001 in which a plurality of jobs are assigned in each shift unit hour of a staff member. Time 3002 is shown in a horizontal axis, and an employee number 3003 and a name 3004 are shown in a vertical axis, and FIG. 30 shows a working shift 3005 in which the assigned jobs for the time are specified. A plurality of arrangement plans can be calculated by repeating to sequentially change the arrangement priority, the skill level, and the combination efficiency similarly to the first embodiment.

Next, for each arrangement plan, productive efficiency which is an index indicating each productivity similarly to the first embodiment is calculated. Further, from the productive efficiency of each job, total productive efficiency is calculated.

A formula 14 expresses one example of calculating the total productive efficiency per unit hour in one arrangement plan.

(total productive efficiency)=(productive efficiency of job A)+(productive efficiency of job B) [Formula 14]

Also, depending on an important degree of each job, each productive efficiency may be weighted, and the total productive efficiency may be calculated. A formula 15 expresses one example of calculating the total productive efficiency per unit hour in one arrangement plan with the weighting for each job.

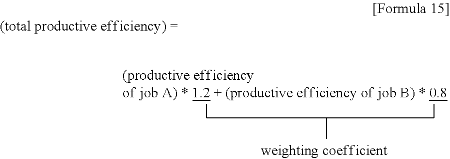

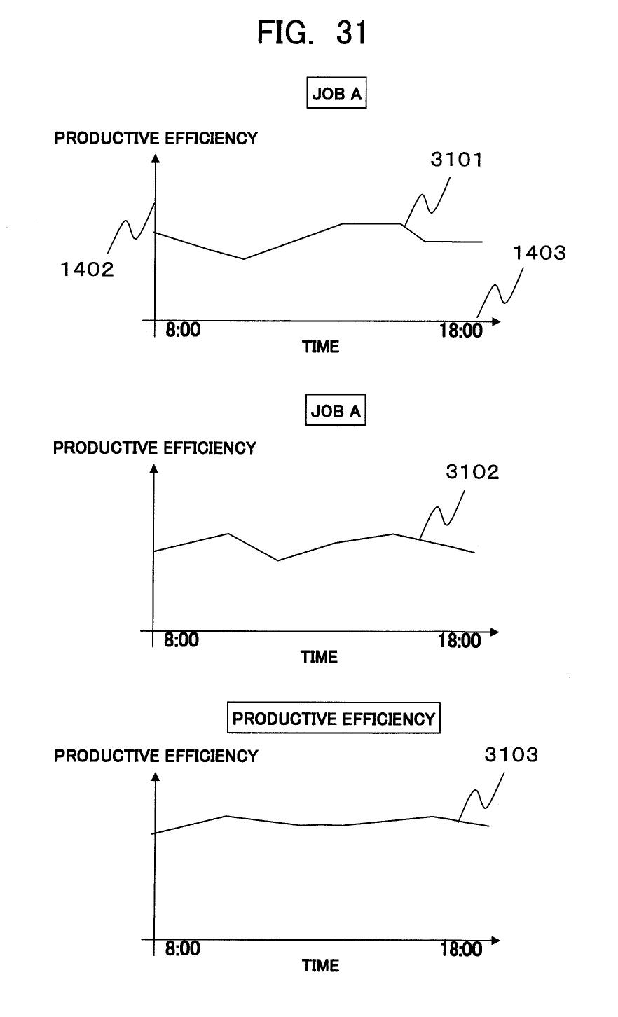

FIG. 31 illustrates one example of a diagram illustrating transition of the predicted productive efficiency and the total productive efficiency in each job on one date. A numerical symbol 3101 denotes the productive efficiency transition of the job A, a numerical symbol 3102 denotes the productive efficiency transition of the job B, and FIG. 31 shows the calculation for the arrangement of optimizing the total productive efficiency 3103. That is, it shows to secure the largest productive efficiency.

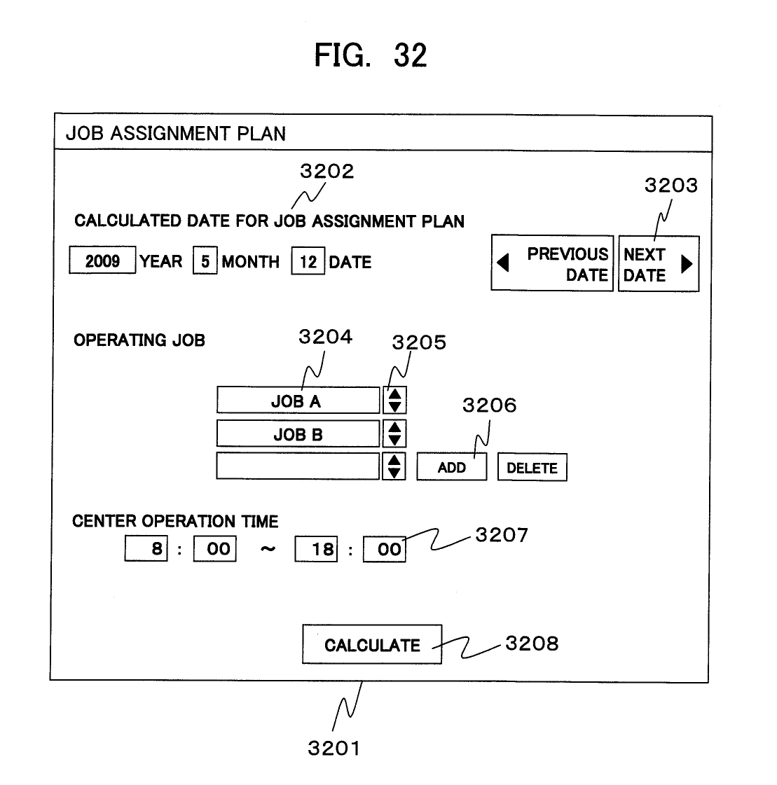

FIG. 32 illustrates one example of an input screen 3201 for starting the arrangement plan calculation in the plurality of different jobs. First, the manager inputs an arrangement-plan calculated date 3202. The date may be changed by a previous/next date button 3203. Next, on an operating job input column 3204, the plurality of jobs of optimizing the productive efficiency are inputted and specified. By a pull-down menu selection button 3205, previously-prepared jobs may be selected. Also, the operating jobs may be added and deleted by an addition/deletion button 3206. The center operation time 3207 is inputted, and the arrangement plan calculation is started by a calculation button 3208.

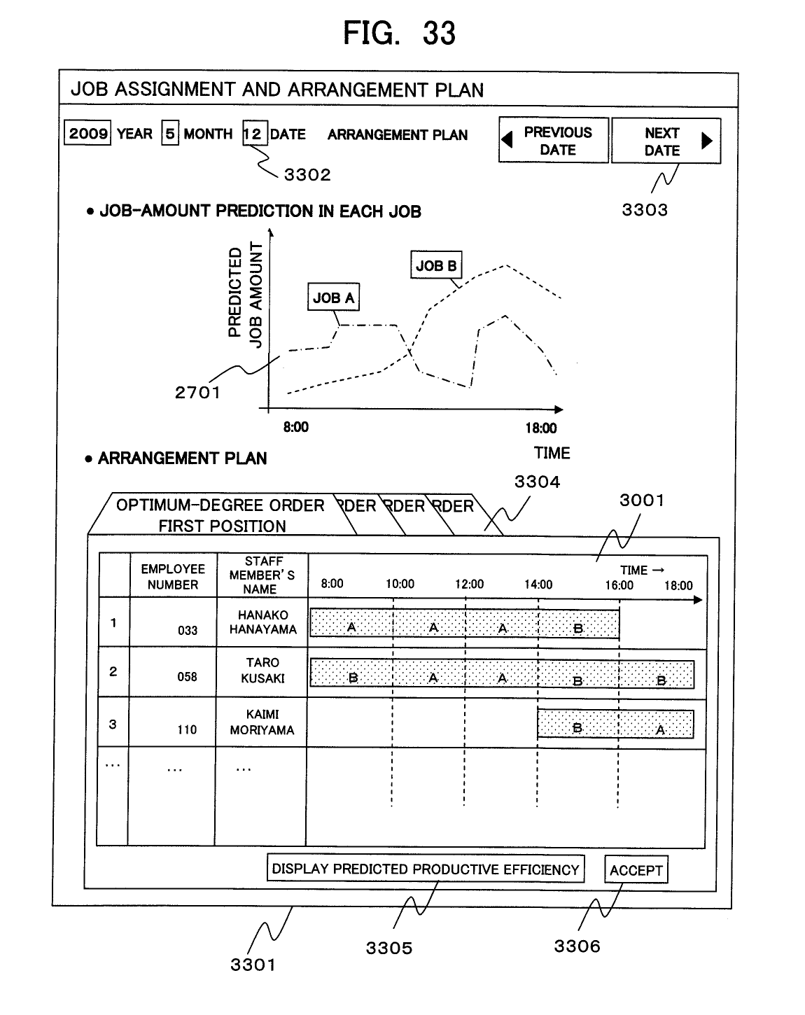

FIG. 33 illustrates one example of an output screen 3301 for a result of the arrangement plan calculation displayed on the output device 106 of the present apparatus. The arrangement plan calculation under the inputted conditions is completed, and the control unit 102 displays the output screen 3301 for the result of the arrangement plan calculation on the output device 106. The output screen 3301 shows a date 3302 of the corresponding arrangement plan and the prediction 2701 of the number of incoming calls in each job described with reference to FIG. 23. The specific date may be changed by a previous/next date button 3303. Also, the staff arrangement plan having the total highest productive efficiency is put on a first position in an optimum-degree order, and the staff arrangement plan 3001 is sequentially displayed in the optimum-degree order. The staff arrangement plan may be switched to be displayed by an optimum-degree-order display tab menu 3304. By a button 3305 for displaying the predicted productive efficiency, the predicted productive efficiency transition 1402 of the displayed arrangement plan may be displayed on another screen. By pressing an acceptance button 3306, a staff arrangement plan accepted from the plurality of staff arrangement plans is determined. In this manner, the accepted arrangement plan may be noticed by sending it to a client PC of the staff member through network or others and displaying it.

### INDUSTRIAL APPLICABILITY

The present invention can be used for a staff arrangement system in a place of work in which a plurality of people share jobs, such as a call center, retail distribution industry, and bank teller window.

1. A staff arrangement system generating staff arrangement for a job performed by a plurality of staff members, the staff arrangement system comprising:
a record database for a job of each of the staff members;
means of calculating combination efficiency between the staff members by referencing the record database for a job of one staff member and a job of another staff member working together in the same hour;
a combination-efficiency database for the staff members for storing the combination efficiency;
means of acquiring a record of a past-generated job amount;
means of predicting a job demand of the job from a record of a past-generated job;
means of calculating a required number of staff members from the predicted job demand;
means of calculating a working shift satisfying the required number of staff members;
means of calculating a working-shift matching degree of each staff member in each of the calculated working shifts based on data of the combination efficiency between the staff members;
means of generating an arrangement plan corresponding to the required number of staff members by sequentially arranging staff members in descending order of the high working-shift matching degree;
means of calculating productive efficiency of the generated arrangement plan; and
means of outputting the arrangement plan as corresponded with the calculated productive efficiency.

2. The staff arrangement system according to claim 1 further comprising:
a skill-level database for a staff member;
means of acquiring a job log of the staff member; and
means of discriminating the skill level of the staff member from the job log of the staff member, wherein
the means of calculating the productive efficiency of the generated arrangement plan calculates the productive efficiency of the arrangement plan from data of the skill level and the combination efficiency.

3. The staff arrangement system according to claim 1 further comprising:
a database for a generated job amount;
means of acquiring a record of the generated job amount;
a database for salary per unit hour of each staff member; and
a skill-level database for each staff member, wherein
the means of calculating the working-shift matching degree calculates the working-shift matching degree from the salary per unit hour of the staff member and the skill level thereof,
the means of generating a plurality of arrangement plans by generating the arrangement plan as sequentially changing the matching degree, and
the means of outputting the arrangement plan as corresponded with the calculated productive efficiency shows the plurality of arrangement plans in an order of the productive efficiency.

4. The staff arrangement system according to claim 1 further comprising:
a profile database for a staff member for storing an attendant state of the staff member;
means of calculating an attendant rate of one staff member from the attendant state;
means of, in the arrangement plan, predicting productive efficiency achieved by the arrangement plan, based on an attendant rate of an already-arranged staff member; and
means of calculating a productive efficiency of the arrangement plan and a feasible probability corresponding to the arrangement plan, wherein,
in the arrangement plan, an arrangement plan having the highest probability for achieving a target productive efficiency in consideration of a member-absent risk is outputted.

5. The staff arrangement system according to claim 1 further comprising:
a skill-level calculation unit for discriminating skill levels of a plurality of different jobs;
a database for storing combination efficiencies of the plurality of different jobs; and
means of calculating a total productive efficiency of the arrangement plan from data of the skill levels of the different jobs and the combination efficiencies of the different jobs.

6. A server connected through network to terminals where each of staff members operates, the server comprising:
a network interface connected through network to each terminal;
a processor connected to the network interface; and
a memory unit connected to the processor, wherein
the processor
acquires a job-operating state of each staff member from each terminal through the network interface and stores it in the memory unit,
calculates combination efficiency between staff members by referencing the memory unit to reference a record database for a job of one staff member and a job of another staff member working together in the same hour,
predicts a job demand of the job from a record of a past-generated job,
generates a working shift satisfying a required number of staff members calculated from the predicted job demand,
calculates a working-shift matching degree of each staff member in each of the generated working shifts based on the combination efficiency of the staff member,
generates an arrangement plan corresponding to the
required number of staff members by sequentially arranging staff members to the working shift in descending order of the high working-shift matching degree,
calculates productive efficiency of the generated arrangement plan, and
outputs the arrangement plan as corresponded with the calculated productive efficiency.
